(19) United States
(12) Patent Application Publication
(10) Pub. No.: US 2023/0135359 A1
(43) Pub. Date: May 4, 2023

(54) LINK ADAPTATION TECHNIQUES BASED ON CHANNEL CONDITIONS

(71) Applicant: QUALCOMM Incorporated, San Diego, CA (US)

(72) Inventors: Mahmoud Taherzadeh Boroujeni, San Diego, CA (US); Tao Luo, San Diego, CA (US); Jelena Damnjanovic, Del Mar, CA (US)

(21) Appl. No.: 17/512,811

(22) Filed: Oct. 28, 2021

(51) Int. Cl. H04W 72/08; H04L 5/00; H04L 1/08; H04W 24/08; H04W 24/10

(52) U.S. Cl. CPC H04W 72/085; H04L 5/0048; H04L 1/08; H04W 24/08; H04W 24/10; H04W 72/044

(57) ABSTRACT

Methods, systems, and devices for wireless communications are described that provide for scheduled communications in which multiple different communication instances may be scheduled between a user equipment (UE) and a base station. Different communication parameters for different communication instances may be selected based on one or more factors, such as channel conditions or a number of prior uplink transmissions. The base station may provide the UE with two or more sets of communication parameters for scheduled communications, and a set of communication parameters may be selected at both the base station and the UE based on channel conditions meeting a defined threshold value, or based on a number of uplink transmissions in a prior time window meeting a defined threshold number.

### FIELD OF TECHNOLOGY

The following relates to wireless communications, including link adaptation techniques based on channel conditions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some cases, base stations may provide UEs with various parameters for wireless communications, such as, for example, wireless resources, modulation orders, coding schemes, repetition schemes, acknowledgment procedures, multiple-input multiple-output (MIMO) schemes, or combinations thereof. Such communications parameters may be adjusted based on various factors, such as conditions of a channel between the UE and base station (e.g., based on a measured amount of interference or received powers of signals), load factors (e.g., an amount of traffic being served by a base station), priorities of different communications (e.g., higher priority communications versus best efforts data transmissions), among others. Efficient adjustment of such communications parameters may help to enhance network efficiency and reliability.

### SUMMARY

The described techniques relate to improved methods, systems, devices, and apparatuses that support link adaptation techniques based on channel conditions. In accordance with various aspects, the described techniques provide for scheduled communications in which multiple different communication instances are scheduled between a user equipment (UE) and a base station, and different communication parameters for different communication instances may be selected based on one or more factors without additional control signaling associated with a particular communication instance. In some cases, the base station may provide a UE with two or more sets of communication parameters for scheduled communications, and a first set of communication parameters may be selected at both the base station and the UE based at least in part on channel conditions meeting a first threshold value. In the event that channel conditions meet a second threshold value, the UE and base station may switch to a second set of communication parameters from the two or more sets of communication parameters. Such techniques provide that communication parameters may be adjusted based on channel conditions. Further, in some cases, different threshold values may be provided for switching to and from a set of communications parameters.

Additionally, or alternatively, a set of communication parameters may be selected based at least in part on a number of uplink communications between the UE and the base station during a prior time window. In such cases, if a number of uplink communications in the prior time window meet or exceed a threshold number, a set of communication parameters may be selected that provide for increased data rates or lower resource allocations. In the event that the number of uplink communications in the prior time window are below the threshold number, a different set of communication parameters may be selected that provide for reduced data rates or higher resource allocations. Such techniques may allow for a base station to adjust one or more beamforming parameters based on an initial number of uplink communications, which may allow for more efficient communications for subsequent uplink communications.

A method for wireless communication at a user equipment (UE) is described. The method may include receiving, from a base station, an indication of two or more sets of communication parameters for a set of multiple scheduled communications between the UE and the base station, selecting, based on a first set of channel conditions between the UE and the base station meeting a first threshold value, a first set of communication parameters from the two or more sets of communication parameters, communicating with the base station according to the selected first set of communication parameters for at least a first communication of the set of multiple scheduled communications, selecting, based on a second set of channel conditions between the UE and the base station meeting a second threshold value, a second set of communication parameters from the two or more sets of communication parameters, where the first threshold value is different than the second threshold value, and communicating with the base station according to the selected second set of communication parameters for at least a second communication of the set of multiple scheduled communications.

An apparatus for wireless communication at a UE is described. The apparatus may include a processor, memory coupled with the processor, and instructions stored in the memory. The instructions may be executable by the processor to cause the apparatus to receive, from a base station, an indication of two or more sets of communication parameters for a set of multiple scheduled communications between the UE and the base station, select, based on a first set of channel conditions between the UE and the base station meeting a first threshold value, a first set of communication parameters from the two or more sets of communication parameters, communicate with the base station according to the selected first set of communication parameters for at least a first communication of the set of multiple scheduled communications, select, based on a second set of channel conditions between the UE and the base station meeting a second threshold value, a second set of communication parameters from the two or more sets of communication parameters, where the first threshold value is different than the second threshold value, and communicate with the base station according to the selected second set of communication parameters for at least a second communication of the set of multiple scheduled communications.

Another apparatus for wireless communication at a UE is described. The apparatus may include means for receiving, from a base station, an indication of two or more sets of communication parameters for a set of multiple scheduled communications between the UE and the base station, means for selecting, based on a first set of channel conditions between the UE and the base station meeting a first threshold value, a first set of communication parameters from the two or more sets of communication parameters, means for communicating with the base station according to the selected first set of communication parameters for at least a first communication of the set of multiple scheduled communications, means for selecting, based on a second set of channel conditions between the UE and the base station meeting a second threshold value, a second set of communication parameters from the two or more sets of communication parameters, where the first threshold value is different than the second threshold value, and means for communicating with the base station according to the selected second set of communication parameters for at least a second communication of the set of multiple scheduled communications.

A non-transitory computer-readable medium storing code for wireless communication at a UE is described. The code may include instructions executable by a processor to receive, from a base station, an indication of two or more sets of communication parameters for a set of multiple scheduled communications between the UE and the base station, select, based on a first set of channel conditions between the UE and the base station meeting a first threshold value, a first set of communication parameters from the two or more sets of communication parameters, communicate with the base station according to the selected first set of communication parameters for at least a first communication of the set of multiple scheduled communications, select, based on a second set of channel conditions between the UE and the base station meeting a second threshold value, a second set of communication parameters from the two or more sets of communication parameters, where the first threshold value is different than the second threshold value, and communicate with the base station according to the selected second set of communication parameters for at least a second communication of the set of multiple scheduled communications.

In some examples of the method, apparatuses, and non-transitory computer-readable medium described herein, the second set of communication parameters provide resources for multiple repetitions of at least the second communication according to a coverage enhancement configuration, and where the first set of communication parameters provide fewer resources than the second set of communication parameters for fewer or no repetitions of the first communication. In some examples of the method, apparatuses, and non-transitory computer-readable medium described herein, the first threshold value for selecting the first set of communication parameters is higher than the second threshold value for selecting the second set of communication parameters. In some examples of the method, apparatuses, and non-transitory computer-readable medium described herein, the first set of channel conditions and the second set of channel conditions each include one or more of a reference signal received power (RSRP) measurement, a signal to interference and noise ratio (SINR), or a channel quality indicator (CQI) measurement.

Some examples of the method, apparatuses, and non-transitory computer-readable medium described herein, may further include operations, features, means, or instructions for measuring the first set of channel conditions between the UE and the base station and transmitting a measurement report to the base station that includes the first set of channel conditions, and where the first set of communication parameters are selected based on the measurement report. In some examples of the method, apparatuses, and non-transitory computer-readable medium described herein, the second set of communication parameters: provides an increased number of repetitions of communications relative to the first set of communication parameters, provides frequency hopping among multiple repetitions of the second communication, provide a different uplink control channel format or resource set than provided by the first set of communication parameters, indicates a different modulation and coding scheme (MCS) than a MCS of the first set of communication parameters, indicates different time or frequency resources for communications than the first set of communication parameters, resources, or any combinations thereof. In some examples of the method, apparatuses, and non-transitory computer-readable medium described herein, the two or more sets of communication parameters include two or more sets of configured grant parameters for uplink transmissions to the base station, include two or more sets of semi-persistent scheduling parameters for downlink transmissions from the base station, or any combinations thereof.

A method for wireless communication at a UE is described. The method may include receiving, from a base station, an indication of two or more sets of communication parameters for a set of multiple scheduled downlink communications from the base station, selecting, based on a number of uplink communications to the base station during a prior time window, a first set of communication parameters from the two or more sets of communication parameters, and communicating with the base station according to the selected first set of communication parameters.

An apparatus for wireless communication at a UE is described. The apparatus may include a processor, memory coupled with the processor, and instructions stored in the memory. The instructions may be executable by the processor to cause the apparatus to receive, from a base station, an indication of two or more sets of communication parameters for a set of multiple scheduled downlink communications from the base station, select, based on a number of uplink communications to the base station during a prior time window, a first set of communication parameters from the two or more sets of communication parameters, and communicate with the base station according to the selected first set of communication parameters.

Another apparatus for wireless communication at a UE is described. The apparatus may include means for receiving, from a base station, an indication of two or more sets of communication parameters for a set of multiple scheduled downlink communications from the base station, means for selecting, based on a number of uplink communications to the base station during a prior time window, a first set of communication parameters from the two or more sets of communication parameters, and means for communicating with the base station according to the selected first set of communication parameters.

A non-transitory computer-readable medium storing code for wireless communication at a UE is described. The code may include instructions executable by a processor to receive, from a base station, an indication of two or more sets of communication parameters for a set of multiple scheduled downlink communications from the base station, select, based on a number of uplink communications to the base station during a prior time window, a first set of communication parameters from the two or more sets of communication parameters, and communicate with the base station according to the selected first set of communication parameters.

In some examples of the method, apparatuses, and non-transitory computer-readable medium described herein, the first set of communication parameters provide for an increased data rate for communications with the base station than a second set of communication parameters of the two or more sets of communication parameters, and where the first set of communication parameters are selected based on the number of uplink communications during the prior time window being above a threshold value. Some examples of the method, apparatuses, and non-transitory computer-readable medium described herein may further include operations, features, means, or instructions for receiving, from the base station, configuration information that indicates a duration of the prior time window. In some examples of the method, apparatuses, and non-transitory computer-readable medium described herein, the duration of the prior time window may be based on one or more of a prior number of slots, a prior number of scheduled downlink communications monitoring occasions, or an absolute time value.

In some examples of the method, apparatuses, and non-transitory computer-readable medium described herein, different sets of communication parameters of the two or more sets of communication parameters provide one or more of different time resources, different frequency resources, different modulation and coding schemes, different MIMO ranks, or any combinations thereof. Some examples of the method, apparatuses, and non-transitory computer-readable medium described herein may further include operations, features, means, or instructions for determining a duration of the prior time window based at least in part on whether the UE is configured to transmit acknowledgment-only feedback or acknowledgment/negative-acknowledgment feedback for the set of multiple scheduled downlink communications.

In some examples of the method, apparatuses, and non-transitory computer-readable medium described herein, each of the two or more sets of communication parameters are associated with different ranges of the number of uplink communications to the base station during the prior time window. In some examples of the method, apparatuses, and non-transitory computer-readable medium described herein, each of the two or more sets of communication parameters provide different link-budget gains over a baseline link budget estimate. In some examples of the method, apparatuses, and non-transitory computer-readable medium described herein, the selecting may be further based on the set of multiple scheduled downlink communications having a same transmission configuration indicator (TCI) state and beam as the number of uplink communications to the base station during the prior time window.

A method for wireless communication at a base station is described. The method may include transmitting, to a UE, from a base station, an indication of two or more sets of communication parameters for a set of multiple scheduled communications between the UE and the base station, selecting, based on a first set of channel conditions between the UE and the base station meeting a first threshold value, a first set of communication parameters from the two or more sets of communication parameters, communicating with the UE according to the selected first set of communication parameters for at least a first communication of the set of multiple scheduled communications, selecting, based on a second set of channel conditions between the UE and the base station meeting a second threshold value, a second set of communication parameters from the two or more sets of communication parameters, where the first threshold value is different than the second threshold value, and communicating with the UE according to the selected second set of communication parameters for at least a second communication of the set of multiple scheduled communications.

An apparatus for wireless communication at a base station is described. The apparatus may include a processor, memory coupled with the processor, and instructions stored in the memory. The instructions may be executable by the processor to cause the apparatus to transmit, to a UE, from a base station, an indication of two or more sets of communication parameters for a set of multiple scheduled communications between the UE and the base station, select, based on a first set of channel conditions between the UE and the base station meeting a first threshold value, a first set of communication parameters from the two or more sets of communication parameters, communicate with the UE according to the selected first set of communication parameters for at least a first communication of the set of multiple scheduled communications, select, based on a second set of channel conditions between the UE and the base station meeting a second threshold value, a second set of communication parameters from the two or more sets of communication parameters, where the first threshold value is different than the second threshold value, and communicate with the UE according to the selected second set of communication parameters for at least a second communication of the set of multiple scheduled communications.

Another apparatus for wireless communication at a base station is described. The apparatus may include means for transmitting, to a UE, from a base station, an indication of two or more sets of communication parameters for a set of multiple scheduled communications between the UE and the base station, means for selecting, based on a first set of channel conditions between the UE and the base station meeting a first threshold value, a first set of communication parameters from the two or more sets of communication parameters, means for communicating with the UE according to the selected first set of communication parameters for at least a first communication of the set of multiple scheduled communications, means for selecting, based on a second set of channel conditions between the UE and the base station meeting a second threshold value, a second set of communication parameters from the two or more sets of communication parameters, where the first threshold value is different than the second threshold value, and means for communicating with the UE according to the selected second set of communication parameters for at least a second communication of the set of multiple scheduled communications.

A non-transitory computer-readable medium storing code for wireless communication at a base station is described. The code may include instructions executable by a processor to transmit, to a UE, from a base station, an indication of two or more sets of communication parameters for a set of multiple scheduled communications between the UE and the base station, select, based on a first set of channel conditions between the UE and the base station meeting a first threshold value, a first set of communication parameters from the two or more sets of communication parameters, communicate with the UE according to the selected first set of communication parameters for at least a first communication of the set of multiple scheduled communications, select, based on a second set of channel conditions between the UE and the base station meeting a second threshold value, a second set of communication parameters from the two or more sets of communication parameters, where the first threshold value is different than the second threshold value, and communicate with the UE according to the selected second set of communication parameters for at least a second communication of the set of multiple scheduled communications.

In some examples of the method, apparatuses, and non-transitory computer-readable medium described herein, the second set of communication parameters provide resources for multiple repetitions of at least the second communication according to a coverage enhancement configuration, and where the first set of communication parameters provide fewer resources than the second set of communication parameters for fewer or no repetitions of the first communication.

In some examples of the method, apparatuses, and non-transitory computer-readable medium described herein, the first threshold value for selecting the first set of communication parameters is higher than the second threshold value for selecting the second set of communication parameters. In some examples of the method, apparatuses, and non-transitory computer-readable medium described herein, the first set of channel conditions and the second set of channel conditions each include one or more of a RSRP measurement, a SINR, or a CQI measurement. Some examples of the method, apparatuses, and non-transitory computer-readable medium described herein may further include operations, features, means, or instructions for receiving, from the UE, a measurement report that includes the first set of channel conditions, and where the first set of communication parameters are selected based on the measurement report.

In some examples of the method, apparatuses, and non-transitory computer-readable medium described herein, the second set of communication parameters, provides an increased number of repetitions of communications relative to the first set of communication parameters, provides frequency hopping among multiple repetitions of the second communication, provide a different uplink control channel format or resource set than provided by the first set of communication parameters, indicates a different MCS than a MCS of the first set of communication parameters, indicates different time or frequency resources for communications than the first set of communication parameters, resources, or any combinations thereof. In some examples of the method, apparatuses, and non-transitory computer-readable medium described herein, the two or more sets of communication parameters include two or more sets of configured grant parameters for uplink transmissions from the UE, include two or more sets of semi-persistent scheduling parameters for downlink transmissions to the UE, or any combinations thereof.

A method for wireless communication at a base station is described. The method may include transmitting, to a UE, an indication of two or more sets of communication parameters for a set of multiple scheduled downlink communications from the base station, selecting, based on a number of uplink communications from the UE during a prior time window, a first set of communication parameters from the two or more sets of communication parameters, and communicating with the UE according to the selected first set of communication parameters.

An apparatus for wireless communication at a base station is described. The apparatus may include a processor, memory coupled with the processor, and instructions stored in the memory. The instructions may be executable by the processor to cause the apparatus to transmit, to a UE, an indication of two or more sets of communication parameters for a set of multiple scheduled downlink communications from the base station, select, based on a number of uplink communications from the UE during a prior time window, a first set of communication parameters from the two or more sets of communication parameters, and communicate with the UE according to the selected first set of communication parameters.

Another apparatus for wireless communication at a base station is described. The apparatus may include means for transmitting, to a UE, an indication of two or more sets of communication parameters for a set of multiple scheduled downlink communications from the base station, means for selecting, based on a number of uplink communications from the UE during a prior time window, a first set of communication parameters from the two or more sets of communication parameters, and means for communicating with the UE according to the selected first set of communication parameters.

A non-transitory computer-readable medium storing code for wireless communication at a base station is described. The code may include instructions executable by a processor to transmit, to a UE, an indication of two or more sets of communication parameters for a set of multiple scheduled downlink communications from the base station, select, based on a number of uplink communications from the UE during a prior time window, a first set of communication parameters from the two or more sets of communication parameters, and communicate with the UE according to the selected first set of communication parameters.

In some examples of the method, apparatuses, and non-transitory computer-readable medium described herein, the first set of communication parameters provide for an increased data rate for communications with the UE than a second set of communication parameters of the two or more sets of communication parameters, and where the first set of communication parameters are selected based on the number of uplink communications during the prior time window being above a threshold value. Some examples of the method, apparatuses, and non-transitory computer-readable medium described herein may further include operations, features, means, or instructions for transmitting, to the UE, configuration information that indicates a duration of the prior time window. In some examples of the method, apparatuses, and non-transitory computer-readable medium described herein, the duration of the prior time window may be based on one or more of a prior number of slots, a prior number of scheduled downlink communications monitoring occasions, or an absolute time value. In some examples of the method, apparatuses, and non-transitory computer-readable medium described herein, different sets of communication parameters of the two or more sets of communication parameters provide one or more of different time resources, different frequency resources, different modulation and coding schemes, different MIMO ranks, or any combinations thereof.

Some examples of the method, apparatuses, and non-transitory computer-readable medium described herein may further include operations, features, means, or instructions for determining a duration of the prior time window based at least in part on whether the UE is configured to transmit acknowledgment-only feedback or acknowledgment/negative-acknowledgment feedback for the set of multiple scheduled downlink communications. In some examples of the method, apparatuses, and non-transitory computer-readable medium described herein, each of the two or more sets of communication parameters are associated with different ranges of the number of uplink communications to the base station during the prior time window. In some examples of the method, apparatuses, and non-transitory computer-readable medium described herein, each of the two or more sets of communication parameters provide different link-budget gains over a baseline link budget estimate. In some examples of the method, apparatuses, and non-transitory computer-readable medium described herein, the selecting may be further based on the set of multiple scheduled downlink communications having a same TCI state and beam as the number of uplink communications from the UE during the prior time window.

### BRIEF DESCRIPTION OF THE DRAWINGS

FIG. 1 illustrates an example of a wireless communications system that supports link adaptation techniques based on channel conditions in accordance with aspects of the present disclosure.

FIGS. 2 through 4 illustrate examples of wireless communications systems that support link adaptation techniques based on channel conditions and uplink communications activity in accordance with aspects of the present disclosure.

FIGS. 5 and 6 illustrate examples of process flows that support link adaptation techniques based on channel conditions in accordance with aspects of the present disclosure.

FIGS. 7 and 8 show block diagrams of devices that support link adaptation techniques based on channel conditions in accordance with aspects of the present disclosure.

FIG. 9 shows a block diagram of a communications manager that supports link adaptation techniques based on channel conditions in accordance with aspects of the present disclosure.

FIG. 10 shows a diagram of a system including a device that supports link adaptation techniques based on channel conditions in accordance with aspects of the present disclosure.

FIGS. 11 and 12 show block diagrams of devices that support link adaptation techniques based on channel conditions in accordance with aspects of the present disclosure.

FIG. 13 shows a block diagram of a communications manager that supports link adaptation techniques based on channel conditions in accordance with aspects of the present disclosure.

FIG. 14 shows a diagram of a system including a device that supports link adaptation techniques based on channel conditions in accordance with aspects of the present disclosure.

FIGS. 15 through 22 show flowcharts illustrating methods that support link adaptation techniques based on channel conditions in accordance with aspects of the present disclosure.

### DETAILED DESCRIPTION

Various wireless communications systems may employ link adaptation techniques to provide a data bandwidth that is tuned based on channel conditions between a transmitting device (e.g., a user equipment (UE) or a base station) and a receiving device (e.g., a UE or a base station). Link adaptation, for example, may include adjustments to an amount of resources for communications, a modulation and coding scheme (MCS) of communications, a multiple-input multiple-output (MIMO) rank for communications, activation or deactivation of coverage enhancement (CE) techniques, or combinations thereof. Link adaptation may be implemented by a base station through scheduling information (e.g., provided in a scheduling downlink control information (DCI) transmission) that indicates communications parameters for scheduled uplink or downlink transmissions (e.g., MCS, MIMO rank, CE). However, in some cases a base station and UE may be scheduled for a series of communications in which separate scheduling information is not provided for each particular communication instance. For example, a semi-persistent scheduling (SPS) configuration may be provided for a series of downlink communications, or a configured grant (CG) may be provided for a series of uplink communications, in which multiple instances of communications may be transmitted without a new resource grant. In such cases, existing techniques to not provide for link adaptation for different communications in the series of scheduled communications, which can lead to reduced communications efficiency when channel conditions change over the course of the scheduled communications instances.

In accordance with various aspects of the present disclosure, scheduled communications may be performed in which different communication parameters for different communication instances may be selected based on one or more factors, without additional control signaling associated with a particular communication instance. In some cases, a base station may provide a UE with two or more sets of communication parameters for scheduled communications, and a first set of communication parameters may be selected at both the base station and the UE based at least in part on channel conditions meeting a first threshold value (e.g., based on a value reported by the UE in a measurement report). In the event that channel conditions meet a second threshold value (e.g., based on a subsequent value reported in a subsequent measurement report), the UE and base station may switch to a second set of communication parameters from the two or more sets of communication parameters. Such techniques provide that communication parameters may be adjusted based on channel conditions. Further, in some cases, different threshold values may be provided for switching to and from a set of communications parameters.

Additionally, or alternatively, a set of communication parameters may be selected based at least in part on a number of uplink communications between the UE and the base station during a prior time window. In such cases, if a number of uplink communications in the prior time window meet or exceed a threshold number, a set of communication parameters may be selected that provide for increased data rates or lower resource allocations, or both. In the event that the number of uplink communications in the prior time window are below the threshold number, a different set of communication parameters may be selected that provide for reduced data rates or higher resource allocations, or both. Such techniques may allow for a base station to adjust one or more beamforming parameters based on an initial number of uplink communications, which may allow for more efficient communications for subsequent uplink communications. In some cases, the threshold number of uplink communications is set to provide the base station with a sufficient number of uplink transmissions from the UE to determine adjusted beamforming parameters.

Such techniques may provide that a UE and base station operating with scheduled communications can adjust communication parameters to provide efficient and reliable communications. Techniques as discussed herein may thus provide for efficient adjustment of communication parameters based on channel conditions, a number of prior communications, or any combinations thereof. Adjusting communication parameters may allow for enhanced efficiency and reliability of communications with reduced signaling overhead associated with particular instances of scheduled communications. Such techniques may thus enhance communications efficiency, increase data rates and reliability, and provide for enhanced user experience.

Aspects of the disclosure are initially described in the context of wireless communications systems. Aspects of the disclosure are further illustrated by and described with reference to process flows, apparatus diagrams, system diagrams, and flowcharts that relate to link adaptation techniques based on channel conditions.

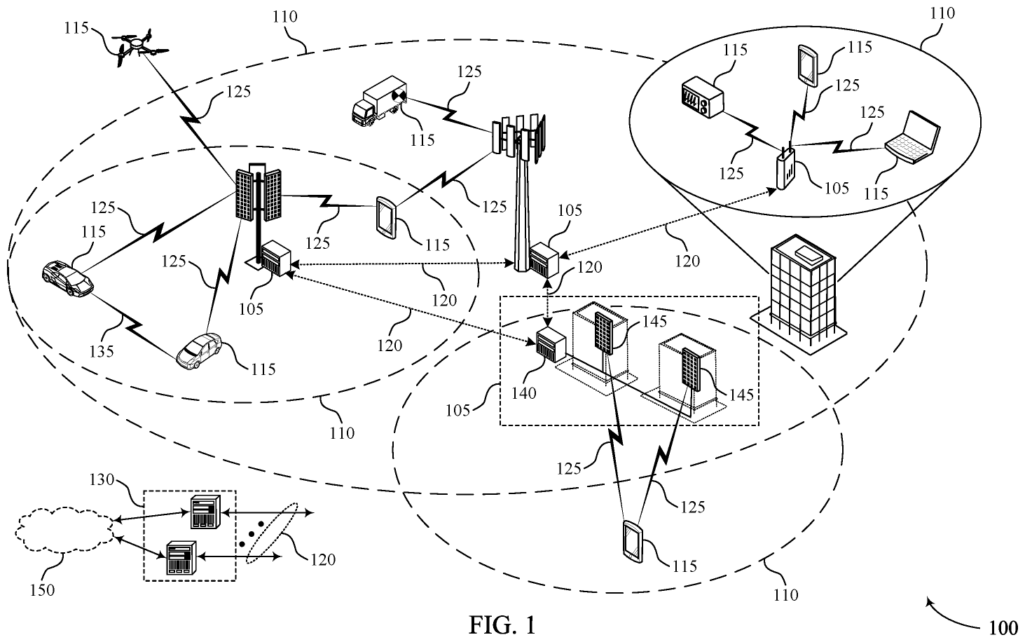

FIG. 1 illustrates an example of a wireless communications system 100 that supports link adaptation techniques based on channel conditions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 and base station 105 may communicate using scheduled communications in which multiple different communication instances are scheduled, and separate control information is not provided for each communication instance. In some cases, different communication parameters for different communication instances may be selected based on one or more factors. In some cases, the base station 105 may provide the UE 115 with two or more sets of communication parameters for scheduled communications, and a first set of communication parameters may be selected at both the base station 105 and the UE 115 based at least in part on channel conditions meeting a first threshold value. In the event that channel conditions meet a second threshold value, the UE 115 and base station 105 may switch to a second set of communication parameters from the two or more sets of communication parameters. Such techniques provide that communication parameters may be adjusted based on channel conditions.

Additionally, or alternatively, a set of communication parameters may be selected based at least in part on a number of uplink communications between the UE 115 and the base station 105 during a prior time window. In such cases, if the number of uplink communications in the prior time window are below a threshold number, a first set of communication parameters may be selected that provide for reduced data rates or higher resource allocations. In the event that a number of uplink communications in the prior time window meet or exceed a threshold number, a second set of communication parameters may be selected that provide for increased data rates or lower resource allocations. Such techniques may allow for a base station 105 to adjust one or more beamforming parameters based on an initial number of uplink communications, which may allow for more efficient communications for subsequent uplink communications.

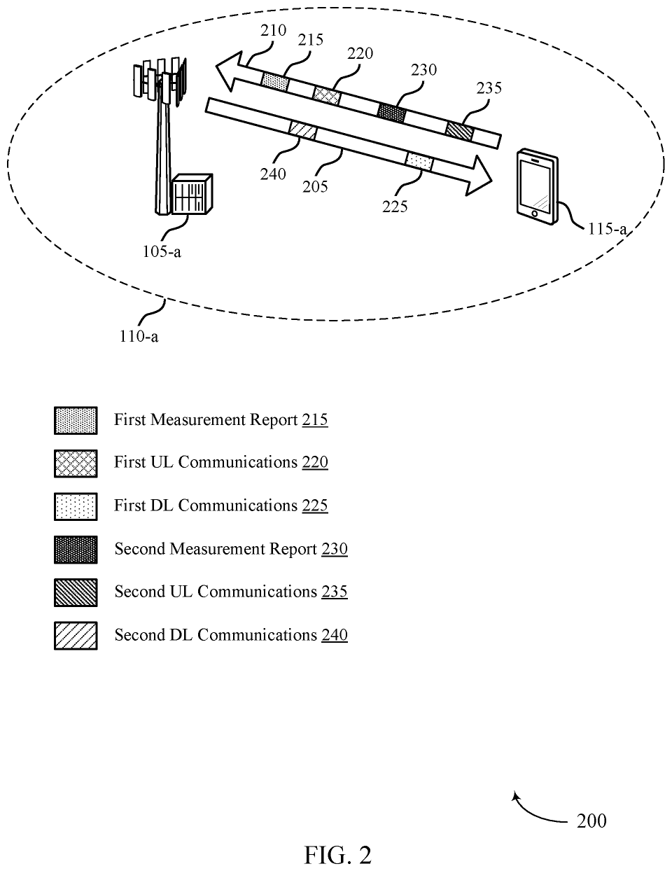

FIG. 2 illustrates an example of a wireless communications systems 200 that supports link adaptation techniques based on channel conditions in accordance with aspects of the present disclosure. In some examples, wireless communications system 200 may implement aspects of wireless communications system 100. In the example of FIG. 2, wireless communications system 200 may include base station 105-a and UE 115-a, which may be examples of the corresponding devices described with respect to FIG. 1. Base station 105-a may provide network coverage for geographic coverage area 110-a. The base station 105-a may transmit downlink communications 205 to the UE 115-a, and the UE 115-a may transmit uplink communications 210 to the base station 105-a.

To support link adaptation for scheduled communications (e.g., CG or SPS communications) in which multiple communication instances may occur using wireless resources that are provided in control information, the UE 115-a and base station 105-a may select communication parameters based on one or more factors. In some cases, the base station 105-a may provide the UE 115-a with control information that indicates multiple sets of communication parameters. For example, each set of communication parameters may indicate a wireless resource allocation and a MCS for data transmissions, and different sets of communication parameters may provide different resource allocations, different MCSs, or both. The UE 115-a and base station 105-a may select a particular set of communication parameters based on one or more factors. In some cases, the selected set of communication parameters may be based on one or more channel measurements, such that the communication parameters are appropriate for current channel conditions between the UE 115-a and base station 105-a. In some cases, additionally or alternatively, the selected set of communication parameters may be based on a number of uplink communications that have been transmitted within a time window.

In the example of FIG. 2, the UE 115-a may transmit a first measurement report 215 to the base station 105-a. Based on one or more measured parameters reported in the first measurement report 215 (e.g., measured reference signal powers), the base station 105-a and UE 115-a may select one of the sets of communication parameters. For example, a first set of communication parameters may include resource allocations (e.g., time and frequency resources) and MCS for coverage enhancement transmissions, and be selected when a reference signal received power (RSRP) or signal to interference and noise ratio (SINR) is below a threshold value. Based on the selected set of communication parameters, the UE 115-a may transmit (and the base station 105-a may receive) a first uplink communication 220, and the base station 105-a may transmit (and the UE 115-a may receive) a first downlink communication 225.

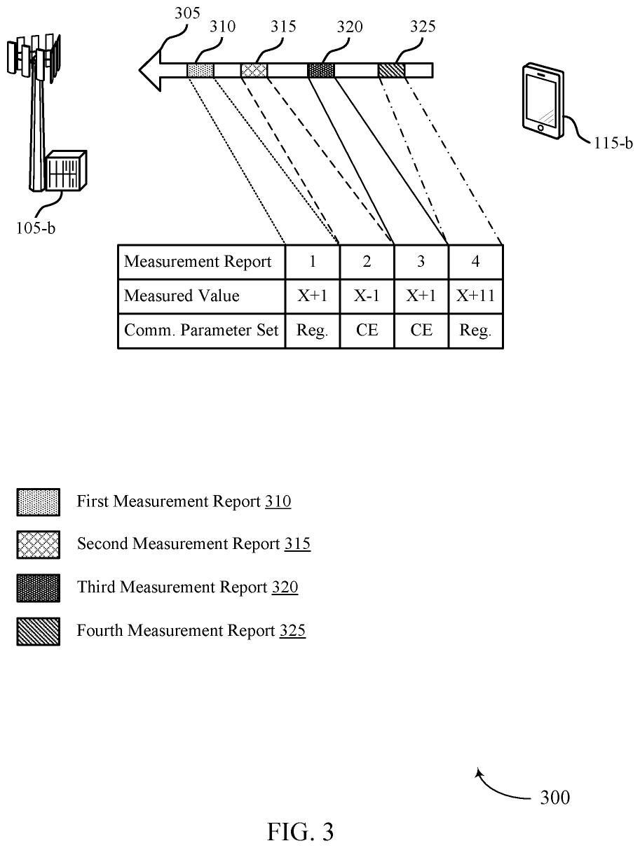

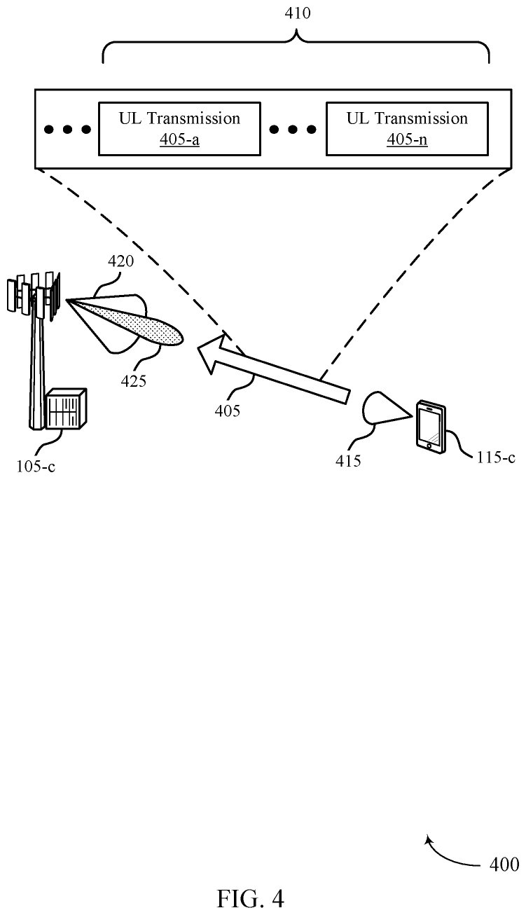

In some cases, the base station 105-a may transmit one or more reference signals (e.g., a channel state information reference signal (CSI-RS)) that may be measured at the UE 115-a, and a second measurement report 230 may be transmitted based on measurements of the one or more reference signals. In some cases, the second measurement report 230 may indicate that the one or more measured parameters are above a second threshold value (e.g., a measured RSRP is above the second threshold value) and the UE 115-a and base station 105-a may select a different set of communication parameters for a second uplink communication 235 and a second downlink communication 240. For example, the second measurement report 230 may indicate that channel conditions have improved sufficiently and that CE is no longer necessary, and the different set of communication parameters may include resource allocations and MCS for regular, non-CE, communications (e.g., CE communications may have a lower modulation order and coding rate, with multiple repetitions transmitted, and regular communications may have a higher modulation order and coding rate, with fewer or no repetitions). An example of communication parameter sets that are selected based on measurement thresholds and measured parameters is discussed with reference to FIG. 3. In other cases, additionally or alternatively, communication parameters may be selected based on a number of uplink transmissions within a prior time window, an example of which is discussed with reference to FIG. 4.

FIG. 3 illustrates an example of a wireless communications system 300 that supports link adaptation techniques based on channel conditions in accordance with aspects of the present disclosure. In some examples, wireless communications system 300 may implement aspects of wireless communications system 100 or 200. In the example of FIG. 3, wireless communications system 300 may include base station 105-b and UE 115-b, which may be examples of the corresponding devices described with respect to FIG. 1. The base station 105-b may transmit downlink communications to the UE 115-b, and the UE 115-b may transmit uplink communications 305 to the base station 105-b.

As discussed herein, to support link adaptation for scheduled communications (e.g., CG or SPS communications) in which multiple communication instances may occur using wireless resources that are provided in control information, in some examples the UE 115-b and base station 105-b may select communication parameters based on reported measurements (e.g., RSRP, SINR, etc.) provided by the UE 115-b in one or more measurement reports. In the example of FIG. 3, a first measurement report 310 may include a first measured value of X+1, where X is a threshold value for switching between a first set of parameters for regular communications and a second set of parameters for CE communications. In this example, because the first measured value is greater than the threshold value, the UE 115-b and base station 105-b may communicate using the communication parameter set for regular communications.

Continuing with the example of FIG. 3, a second measurement report 315 may have a second measured value of X−1, and based on this value being less than the threshold value, the UE 115-b and base station 105-b may switch to a second set of parameters for CE communications. In accordance with various aspects, the threshold for then switching back to the first set of parameters for regular communications may be different than the threshold for switching to CE communications (e.g., a second threshold value for switching back to the first set of parameters for regular communications may be X+10). Such different threshold values for switching between regular and CE communications may provide hysteresis and avoid ping-ponging between regular and CE communications. In this example, a third measurement report 320 may again have the value of X+1, but based on the hysteresis the UE 115-b and base station 105-b continue to use the second set of parameters for CE communications, and it is not until a fourth measurement report 325 that reports a value of X+11, where the second threshold for switching back to the first set of parameters for regular communications is X+10, that the UE 115-b and base station 105-b switch back to the first set of parameters for regular communications.

In some cases, the measurement reports 310 through 325 may be any layer one (L1) measurement report, channel quality indicator (CQI), or other CSI report. As discussed, the different sets of communication parameters may provide different resources (e.g., time, frequency resources), transmission parameters (e.g., MCS), or combinations thereof, for scheduled communications such as CG or SPS communications (or PUCCH communications), depending on configured thresholds and values of one or more L1 report or CQI (or other CSI report), where the threshold for activation of one configuration option is different from the threshold for its deactivation. In some cases, the different sets of communication parameters may indicate different numbers of repetitions for SPS, CG, or PUCCH, whether to perform frequency hopping among repetitions for SPS, CG, or PUCCH, a different PUCCH format or PUCCH resource set, a different MCS for data transmissions, a different set of time/frequency resources for data transmission, or any combinations thereof.

FIG. 4 illustrates an example of a wireless communications system 400 that supports link adaptation techniques based on channel conditions in accordance with aspects of the present disclosure. In some examples, wireless communications system 400 may implement aspects of wireless communications system 100, 200, or 300. In the example of FIG. 4, wireless communications system 400 may include base station 105-c and UE 115-c, which may be examples of the corresponding devices described with respect to FIGS. 1 through 3. The base station 105-c may transmit downlink communications to the UE 115-c, and the UE 115-c may transmit uplink communications 405 to the base station 105-c.

As discussed herein, to support link adaptation for scheduled communications (e.g., CG or SPS communications) in which multiple communication instances may occur using wireless resources that are provided in control information, in some examples the UE 115-c and base station 105-c may select communication parameters based on a number of uplink transmissions 405 that are within a time window 410. For example, if less than a threshold number of uplink transmissions 405 are present within the time window 410, the UE 115-c and base station 105-d may select a first set of communication parameters, and if at least the threshold number of uplink transmissions 405 are present within the time window 410, the UE 115-c and base station 105-d may select a second set of communication parameters. In some cases, the threshold number of uplink transmissions 405 (e.g., n uplink transmissions 405-a through 405-n) may be transmitted by the UE 115-c using transmit beam 415, and may be received at the base station 105-c using a relatively wide first beam 420. Based on the threshold number of uplink transmissions 405, the base station 105-c may perform beam refinement and identify a relatively narrow or more focused second beam 425. The second beam 425 may have a higher beamforming gain than the first beam 420, and may thus support higher data rates and thus support a different MCS than the first beam 420.

In some cases, the base station 105-c may perform one-dimensional or two-dimensional beamforming, where a relatively large number of antenna elements provide possibility of relatively narrow beams. In some cases, for higher frequencies and large arrays, a Fraunhofer near field distance ((2D²)/X) can become comparable or even larger than the coverage, therefore, concentrating power on a specific point can improve the link budget further. For example, for a one-meter transmit array (or a reflective Reconfigurable Intelligent Surface (RIS)) at 28 GHz, the near field distance is 200 meters and at the distance of 50 meters, focal concentration of power can provide up to 12 dB additional link budget (compared to a narrow 2-dimensional beam), which can support a relatively high-rate data transmission with a high modulation order and coding rate. However, such narrow or concentrated 3D beams can be unreliable in the case of mobility. Thus, the time window and threshold number of uplink transmissions may be selected based on such beam characteristics. In some cases, traffic between the UE 115-c and base station 105-c may be bursty traffic in which a relatively high rate of communications may be present for brief periods, and the base station 105-c may be able to refine the beam (e.g., in direction or the focal distance) after a few initial samples of a burst. Thus, in such cases, the threshold number of uplink transmissions 405 in the time window 410 may provide a warm-up period for the base station 105-c to perform beam refinement.

In some cases, the number of uplink transmissions 405 may correspond to a number of transmission instances of a SPS or a number of transmissions of its associated PUCCH (or other UL transmissions) in a past time window, which may be used for beam refinement and affect time/frequency resources, MCS, MIMO rank, or any combinations thereof, of communications between the UE 115-c and base station 105-c. In some cases, the time window 410 may be a predefined window that is specified in a wireless communications standard, or may be a value that is configured by the base station 105-c. The time window 410 may be defined or configured in terms of number of slots, a number of sub-slots, a number of SPS monitoring occasions, an absolute time (e.g., in terms of millisecond), or any combinations thereof. Further, in some cases, criteria for counting SPS PUCCH instances for link adaptation of SPS may be different depending on whether UE is expected to only transmit acknowledgment (ACK) feedback or transmit both ACK and negative acknowledgment (NACK) feedback. In some cases, the base station 105-c may configure different sets of resources and/or transmission parameters (e.g., MCS) for a SPS, corresponding to different ranges of numbers of instances of a SPS or number of transmissions of its associated PUCCH (or other UL transmissions) in time window 410 (e.g., due to different ranges of numbers of SPS transmissions or associated PUCCH (and/or other UL transmissions) that translate to different link-budget gains over a baseline link budget estimate corresponding to L1 reports (e.g., L1-RSRP and/or L1-SINR) or other CSI feedback.

In this case, different ranges of numbers of SPS PUCCH transmissions may implicitly impact transmission parameters of SPS, based on multiple configurations of SPS that are dependent on the L1-SINR (or other CSI) and a link budget gain that is based on the number of SPS PUCCH transmissions. For example, a starting transmissions of SPS may assume the configuration that corresponds the L1-SINR value, but after four SPS PUCCH transmissions inside a preconfigured time window, the equivalent L1-SINR value (for selecting the configuration option) may be added by 6 dB. In some cases, such techniques may be conditioned on a same TCI state and beam association for SPS and its PUCCH, or other uplink transmissions may be counted for the purpose of determination of transmit parameters of a SPS, conditioned on being associated with the same TCI state or UL transmit beam as its PUCCH. In some cases, the base station 105-c may use different beams or analog phases (or both) for reception of different uplink transmission 405 instances, to better estimate an enhanced beam for beam refinement or focal concentration (or both) of power during transmission of SPS. In some cases, the effect of the number of neighboring uplink receptions on an equivalent link budget (of SPS transmission) may depend on the number of RF chains that the base station 105-c uses for uplink reception and downlink transmission.

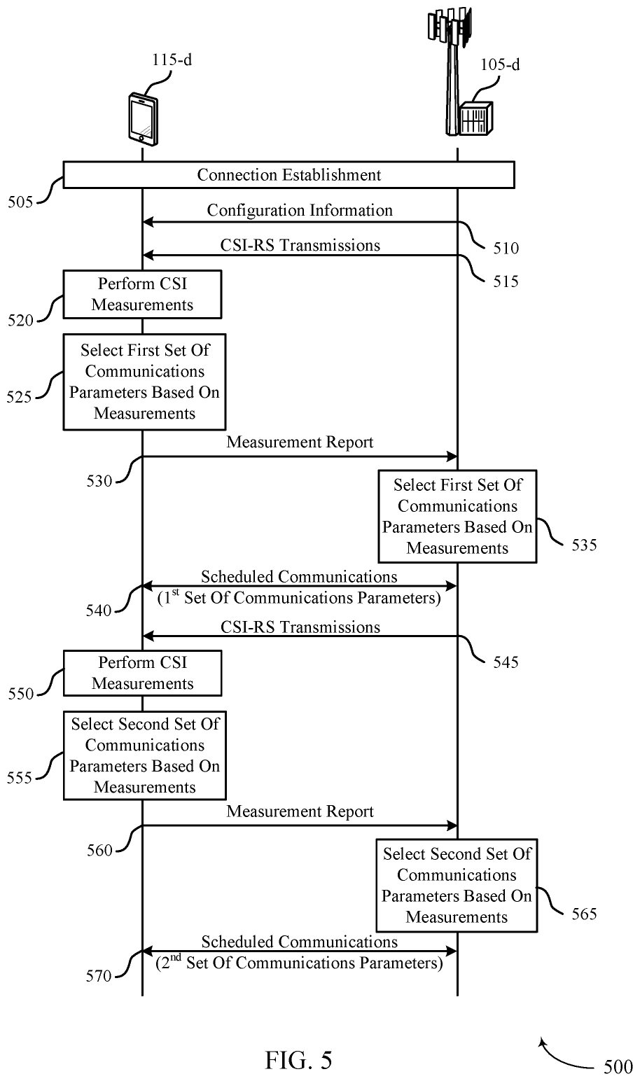

FIG. 5 illustrates an example of a process flow 500 that supports link adaptation techniques based on channel conditions in accordance with aspects of the present disclosure. The process flow 500 may implement or be implemented by aspects of the wireless communications systems 100, 200, 300, or 400. For example, the process flow 500 may include a UE 115-d and a base station 105-d, which may be examples of corresponding devices described with reference to FIGS. 1 through 4. In the following description of the process flow 500, operations between the UE 115-d and the base station 105-d may be performed in a different order or at a different time than as shown. Additionally or alternatively, some operations may be omitted from the process flow 500, and other operations may be added to the process flow 500. In accordance with the process flow 500, the UE 115-d and base station 105-d may communicate using a set of communication parameters that are selected based on channel conditions.

At 505, the UE 115-d and base station 105-d may perform a connection establishment procedure. In some cases, the connection establishment procedure may be an RRC connection establishment or reestablishment procedure that is performed in accordance with known techniques. In some cases, as part of the connection establishment procedure, the UE 115-d may transmit a capability message to the base station 105-d that indicates a capability of the UE 115-d to select communication parameters in scheduled communications based on channel conditions.

At 510, the base station 105-d may transmit control signaling to the UE 115-d with configuration information for scheduled communications (e.g., CG and/or SPS communications). In some cases, the control signaling may include two or more sets of communication parameters, and one or more threshold values for selection of different sets of communication parameters. In some cases, the control signaling may be transmitted to the UE 115-d in RRC signaling, in downlink control information (DCI), in a MAC-CE, or any combinations thereof. At 515, the base station 105-d may transmit one or more CSI-RSs. At 520, the UE 115-d may perform CSI measurements of the one or more CSI-RSs.

At 525, the UE 115-d may select a first set of communication parameters based on one or more CSI measurements. For example, the UE 115-d may measure a RSRP of a CSI-RS and determine that the RSRP is above a first threshold value that is configured for a first set of communication parameters. Based on the measured RSRP value and the first threshold value, the UE 115-d may select the first set of communication parameters. At 530, the UE 115-d may transmit a measurement report to the base station 105-d. At 535, the base station may select the first set of communication parameters based on the one or more CSI measurements and the first threshold value. At 540, the UE 115-d and the base station 105-d may transmit and receive one or more instances of the scheduled communications based on the first set of communication parameters.

At 545, the base station 105-d may again transmit one or more CSI-RSs. At 550, the UE 115-d may perform CSI measurements of the one or more CSI-RSs. At 555, the UE 115-d may select a second set of communication parameters based on one or more CSI measurements relative to the first threshold value. For example, the UE 115-d may measure a RSRP of the CSI-RS and determine that the RSRP is at or below the first threshold value that is configured for the first set of communication parameters, which may indicate that the UE 115-d and the base station 105-d are to switch to the second set of communication parameters. At 560, the UE 115-d may transmit a measurement report to the base station 105-d. At 565, the base station may select the second set of communication parameters based on the one or more CSI measurements and the first threshold value. At 570, the UE 115-d and the base station 105-d may transmit and receive one or more instances of the scheduled communications based on the second set of communication parameters. Such operations may continue with the UE 115-d measuring reference signals from the base station 105-d, and the UE 115-d and base station 105-d switching sets of communication parameters as needed based on reported measurements. As discussed herein, in some cases a second threshold value may be provided (e.g., as a separate threshold value or an offset from the first threshold value) for switching back to the first set of communication parameters after changing to the second set of communication parameters, in order to provide hysteresis and avoid ping-ponging between different sets of communication parameters (e.g., between regular and CE communications). While various examples discussed herein describe two sets of communication parameters, techniques as discussed herein may be used for any number of sets of communication parameters based on respective ranges of one or more channel measurements.

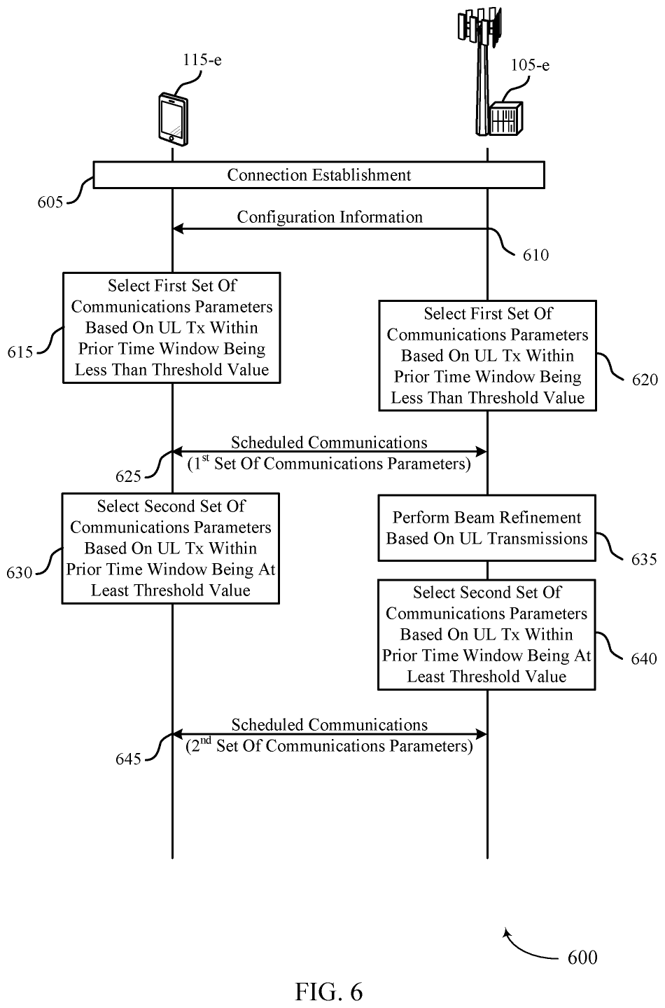

FIG. 6 illustrates an example of a process flow 600 that supports link adaptation techniques based on channel conditions in accordance with aspects of the present disclosure. The process flow 600 may implement or be implemented by aspects of the wireless communications systems 100, 200, 300, or 400. For example, the process flow 600 may include a UE 115-e and a base station 105-e, which may be examples of corresponding devices described with reference to FIGS. 1 through 4. In the following description of the process flow 600, operations between the UE 115-e and the base station 105-e may be performed in a different order or at a different time than as shown. Additionally or alternatively, some operations may be omitted from the process flow 600, and other operations may be added to the process flow 600. In accordance with the process flow 600, the UE 115-e and base station 105-e may communicate using a set of communication parameters that are selected based on channel conditions.

At 605, the UE 115-e and base station 105-e may perform a connection establishment procedure. In some cases, the connection establishment procedure may be an RRC connection establishment or reestablishment procedure that is performed in accordance with known techniques. In some cases, as part of the connection establishment procedure, the UE 115-e may transmit a capability message to the base station 105-e that indicates a capability of the UE 115-e to select communication parameters in scheduled communications based on a number of uplink transmissions in a prior time window.

At 610, the base station 105-e may transmit control signaling to the UE 115-e with configuration information for scheduled communications (e.g., CG and/or SPS communications). In some cases, the control signaling may include two or more sets of communication parameters, and one or more threshold values for selection of different sets of communication parameters. In this example, the one or more threshold values may be provided as a threshold number of uplink transmissions between the UE 115-e and the base station 105-e within a time window (e.g., a prior number of slots, or a prior number of milliseconds, etc.). In some cases, the control signaling may be transmitted to the UE 115-e in RRC signaling, in DCI, in a MAC-CE, or any combinations thereof.

At 615, the UE 115-e may select a first set of communication parameters based on a number of uplink transmissions within the prior time window being below the threshold value. Likewise, at 620, the base station 105-e may select the first set of communication parameters based on the number of uplink transmissions within the prior time window being below the threshold value. At 625, the UE 115-e and the base station 105-e may transmit and receive one or more instances of the scheduled communications based on the first set of communication parameters.

At 630, the base station 105-e may perform beam refinement based on uplink transmissions that are received from the UE 115-e as part of the scheduled communications or separately from the scheduled communications (e.g., other uplink communications that have a same TCI state as the scheduled communications). At 635, the UE 115-e may select a second set of communication parameters based on a number of uplink transmissions within the prior time window being at least the threshold value. Likewise, at 640, the base station 105-e may select the second set of communication parameters based on the number of uplink transmissions within the prior time window being at least the threshold value. At 645, the UE 115-e and the base station 105-e may transmit and receive one or more instances of the scheduled communications based on the second of communication parameters.

Such operations may continue with the set of communication parameters being selected at the UE 115-e and base station 105-e based on whether a number of uplink transmissions within the time window is being less than the threshold value. While various examples discussed herein describe two sets of communication parameters, techniques as discussed herein may be used for any number of sets of communication parameters based on respective ranges of a number of uplink transmissions within one or more prior time periods.

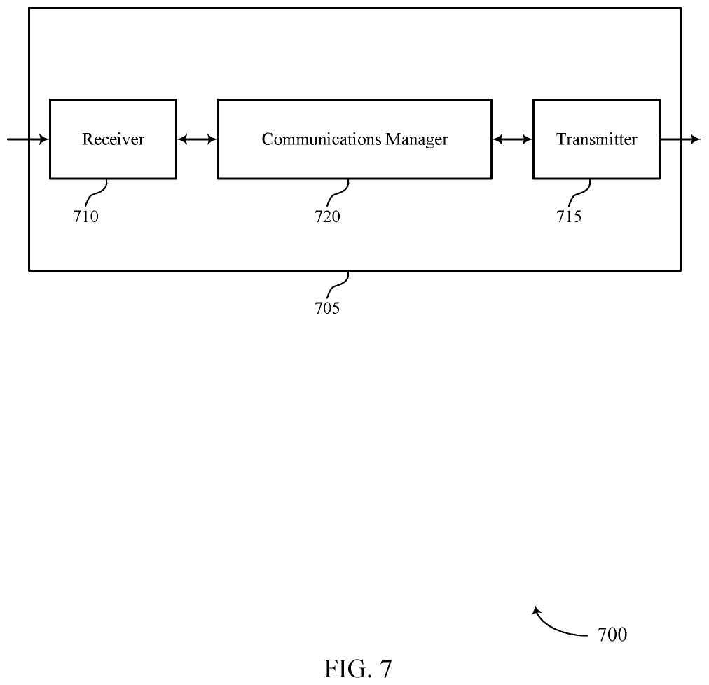

FIG. 7 shows a block diagram 700 of a device 705 that supports link adaptation techniques based on channel conditions in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to link adaptation techniques based on channel conditions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to link adaptation techniques based on channel conditions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of link adaptation techniques based on channel conditions as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for receiving, from a base station, an indication of two or more sets of communication parameters for a set of multiple scheduled communications between the UE and the base station. The communications manager 720 may be configured as or otherwise support a means for selecting, based on a first set of channel conditions between the UE and the base station meeting a first threshold value, a first set of communication parameters from the two or more sets of communication parameters. The communications manager 720 may be configured as or otherwise support a means for communicating with the base station according to the selected first set of communication parameters for at least a first communication of the set of multiple scheduled communications. The communications manager 720 may be configured as or otherwise support a means for selecting, based on a second set of channel conditions between the UE and the base station meeting a second threshold value, a second set of communication parameters from the two or more sets of communication parameters, where the first threshold value is different than the second threshold value. The communications manager 720 may be configured as or otherwise support a means for communicating with the base station according to the selected second set of communication parameters for at least a second communication of the set of multiple scheduled communications.

Additionally or alternatively, the communications manager 720 may support wireless communication at a UE in accordance with examples as disclosed herein. For example, the communications manager 720 may be configured as or otherwise support a means for receiving, from a base station, an indication of two or more sets of communication parameters for a set of multiple scheduled downlink communications from the base station. The communications manager 720 may be configured as or otherwise support a means for selecting, based on a number of uplink communications to the base station during a prior time window, a first set of communication parameters from the two or more sets of communication parameters. The communications manager 720 may be configured as or otherwise support a means for communicating with the base station according to the selected first set of communication parameters.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for efficient adjustment of communication parameters based on channel conditions, a number of prior communications, or any combinations thereof. Adjusting communication parameters may allow for enhanced efficiency and reliability of communications with reduced signaling overhead associated with particular instances of scheduled communications. Such techniques may thus enhance communications efficiency, increase data rates and reliability, and provide for enhanced user experience.

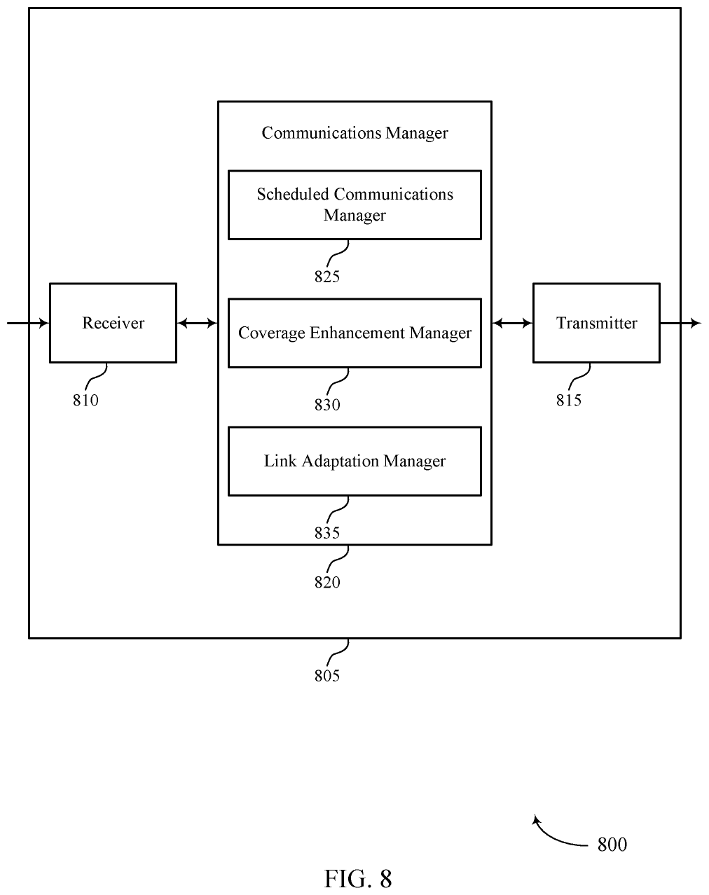

FIG. 8 shows a block diagram 800 of a device 805 that supports link adaptation techniques based on channel conditions in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to link adaptation techniques based on channel conditions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to link adaptation techniques based on channel conditions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of link adaptation techniques based on channel conditions as described herein. For example, the communications manager 820 may include a scheduled communications manager 825, a coverage enhancement manager 830, a link adaptation manager 835, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. The scheduled communications manager 825 may be configured as or otherwise support a means for receiving, from a base station, an indication of two or more sets of communication parameters for a set of multiple scheduled communications between the UE and the base station. The coverage enhancement manager 830 may be configured as or otherwise support a means for selecting, based on a first set of channel conditions between the UE and the base station meeting a first threshold value, a first set of communication parameters from the two or more sets of communication parameters. The scheduled communications manager 825 may be configured as or otherwise support a means for communicating with the base station according to the selected first set of communication parameters for at least a first communication of the set of multiple scheduled communications. The coverage enhancement manager 830 may be configured as or otherwise support a means for selecting, based on a second set of channel conditions between the UE and the base station meeting a second threshold value, a second set of communication parameters from the two or more sets of communication parameters, where the first threshold value is different than the second threshold value. The scheduled communications manager 825 may be configured as or otherwise support a means for communicating with the base station according to the selected second set of communication parameters for at least a second communication of the set of multiple scheduled communications.

Additionally or alternatively, the communications manager 820 may support wireless communication at a UE in accordance with examples as disclosed herein. The scheduled communications manager 825 may be configured as or otherwise support a means for receiving, from a base station, an indication of two or more sets of communication parameters for a set of multiple scheduled downlink communications from the base station. The link adaptation manager 835 may be configured as or otherwise support a means for selecting, based on a number of uplink communications to the base station during a prior time window, a first set of communication parameters from the two or more sets of communication parameters. The scheduled communications manager 825 may be configured as or otherwise support a means for communicating with the base station according to the selected first set of communication parameters.

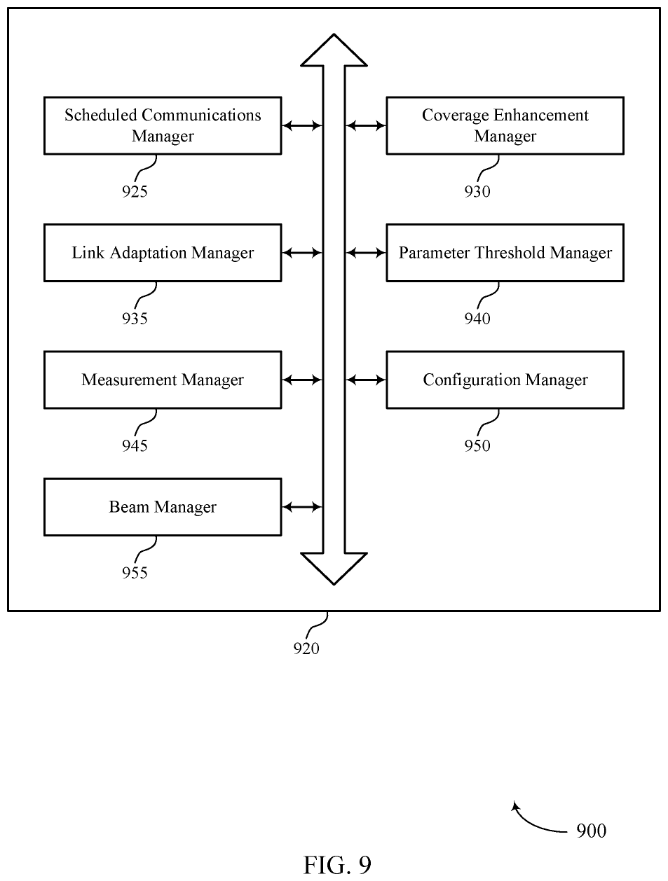

FIG. 9 shows a block diagram 900 of a communications manager 920 that supports link adaptation techniques based on channel conditions in accordance with aspects of the present disclosure. The communications manager 920 may be an example of aspects of a communications manager 720, a communications manager 820, or both, as described herein. The communications manager 920, or various components thereof, may be an example of means for performing various aspects of link adaptation techniques based on channel conditions as described herein. For example, the communications manager 920 may include a scheduled communications manager 925, a coverage enhancement manager 930, a link adaptation manager 935, a parameter threshold manager 940, a measurement manager 945, a configuration manager 950, a beam manager 955, or any combination thereof. Each of these components may communicate, directly or indirectly, with one another (e.g., via one or more buses).

The communications manager 920 may support wireless communication at a UE in accordance with examples as disclosed herein. The scheduled communications manager 925 may be configured as or otherwise support a means for receiving, from a base station, an indication of two or more sets of communication parameters for a set of multiple scheduled communications between the UE and the base station. The coverage enhancement manager 930 may be configured as or otherwise support a means for selecting, based on a first set of channel conditions between the UE and the base station meeting a first threshold value, a first set of communication parameters from the two or more sets of communication parameters. In some examples, the scheduled communications manager 925 may be configured as or otherwise support a means for communicating with the base station according to the selected first set of communication parameters for at least a first communication of the set of multiple scheduled communications. In some examples, the coverage enhancement manager 930 may be configured as or otherwise support a means for selecting, based on a second set of channel conditions between the UE and the base station meeting a second threshold value, a second set of communication parameters from the two or more sets of communication parameters, where the first threshold value is different than the second threshold value. In some examples, the scheduled communications manager 925 may be configured as or otherwise support a means for communicating with the base station according to the selected second set of communication parameters for at least a second communication of the set of multiple scheduled communications.

In some examples, the second set of communication parameters provide resources for multiple repetitions of at least the second communication according to a coverage enhancement configuration, and where the first set of communication parameters provide fewer resources than the second set of communication parameters for fewer or no repetitions of the first communication. In some examples, the first threshold value for selecting the first set of communication parameters is higher than the second threshold value for selecting the second set of communication parameters. In some examples, the first set of channel conditions and the second set of channel conditions each include one or more of a RSRP measurement, a SINR, or a CQI measurement.

In some examples, the measurement manager 945 may be configured as or otherwise support a means for measuring the first set of channel conditions between the UE and the base station. In some examples, the measurement manager 945 may be configured as or otherwise support a means for transmitting a measurement report to the base station that includes the first set of channel conditions, and where the first set of communication parameters are selected based on the measurement report.

In some examples, the second set of communication parameters provides an increased number of repetitions of communications relative to the first set of communication parameters; provides frequency hopping among multiple repetitions of the second communication; provides a different uplink control channel format or resource set than provided by the first set of communication parameters, or any combinations thereof. In some examples, additionally or alternatively, the second set of communication parameters indicates a different MCS than a MCS of the first set of communication parameters, indicates different time or frequency resources for communications than the first set of communication parameters, or any combinations thereof. In some examples, the two or more sets of communication parameters include two or more sets of configured grant parameters for uplink transmissions to the base station, include two or more sets of semi-persistent scheduling parameters for downlink transmissions from the base station, or any combinations thereof.

Additionally or alternatively, the communications manager 920 may support wireless communication at a UE in accordance with examples as disclosed herein. In some examples, the scheduled communications manager 925 may be configured as or otherwise support a means for receiving, from a base station, an indication of two or more sets of communication parameters for a set of multiple scheduled downlink communications from the base station. The link adaptation manager 935 may be configured as or otherwise support a means for selecting, based on a number of uplink communications to the base station during a prior time window, a first set of communication parameters from the two or more sets of communication parameters. In some examples, the scheduled communications manager 925 may be configured as or otherwise support a means for communicating with the base station according to the selected first set of communication parameters.

In some examples, the first set of communication parameters provide for an increased data rate for communications with the base station than a second set of communication parameters of the two or more sets of communication parameters, and where the first set of communication parameters is selected based on the number of uplink communications during the prior time window being above a threshold value.

In some examples, the configuration manager 950 may be configured as or otherwise support a means for receiving, from the base station, configuration information that indicates a duration of the prior time window. In some examples, the duration of the prior time window is based on one or more of a prior number of slots, a prior number of scheduled downlink communications monitoring occasions, or an absolute time value. In some examples, different sets of communication parameters of the two or more sets of communication parameters provide one or more of different time resources, different frequency resources, different MCSs, different MIMO ranks, or any combinations thereof.

In some examples, the link adaptation manager 935 may be configured as or otherwise support a means for determining a duration of the prior time window based at least in part on whether the UE is configured to transmit acknowledgment-only feedback or acknowledgment/negative-acknowledgment feedback for the set of multiple scheduled downlink communications. In some examples, each of the two or more sets of communication parameters are associated with different ranges of the number of uplink communications to the base station during the prior time window. In some examples, each of the two or more sets of communication parameters provide different link-budget gains over a baseline link budget estimate. In some examples, the selecting is further based on the set of multiple scheduled downlink communications having a same TCI state and beam as the number of uplink communications to the base station during the prior time window.

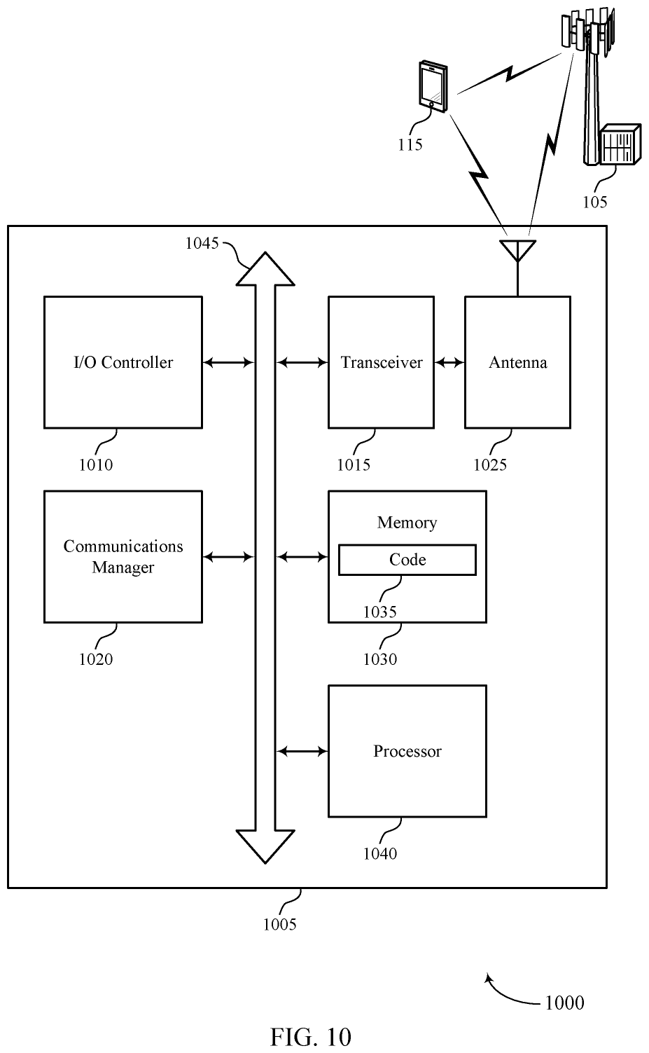

FIG. 10 shows a diagram of a system 1000 including a device 1005 that supports link adaptation techniques based on channel conditions in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions.

The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting link adaptation techniques based on channel conditions). For example, the device 1005 or a component of the device 1005 may include a processor 1040 and memory 1030 coupled with the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving, from a base station, an indication of two or more sets of communication parameters for a set of multiple scheduled communications between the UE and the base station. The communications manager 1020 may be configured as or otherwise support a means for selecting, based on a first set of channel conditions between the UE and the base station meeting a first threshold value, a first set of communication parameters from the two or more sets of communication parameters. The communications manager 1020 may be configured as or otherwise support a means for communicating with the base station according to the selected first set of communication parameters for at least a first communication of the set of multiple scheduled communications. The communications manager 1020 may be configured as or otherwise support a means for selecting, based on a second set of channel conditions between the UE and the base station meeting a second threshold value, a second set of communication parameters from the two or more sets of communication parameters, where the first threshold value is different than the second threshold value. The communications manager 1020 may be configured as or otherwise support a means for communicating with the base station according to the selected second set of communication parameters for at least a second communication of the set of multiple scheduled communications.

Additionally or alternatively, the communications manager 1020 may support wireless communication at a UE in accordance with examples as disclosed herein. For example, the communications manager 1020 may be configured as or otherwise support a means for receiving, from a base station, an indication of two or more sets of communication parameters for a set of multiple scheduled downlink communications from the base station. The communications manager 1020 may be configured as or otherwise support a means for selecting, based on a number of uplink communications to the base station during a prior time window, a first set of communication parameters from the two or more sets of communication parameters. The communications manager 1020 may be configured as or otherwise support a means for communicating with the base station according to the selected first set of communication parameters.

By including or configuring the communications manager 1020 in accordance with examples as described herein, the device 1005 may support techniques for efficient adjustment of communication parameters based on channel conditions, a number of prior communications, or any combinations thereof. Adjusting communication parameters may allow for enhanced efficiency and reliability of communications with reduced signaling overhead associated with particular instances of scheduled communications. Such techniques may thus enhance communications efficiency, increase data rates and reliability, and provide for enhanced user experience.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of link adaptation techniques based on channel conditions as described herein, or the processor 1040 and the memory 1030 may be otherwise configured to perform or support such operations.

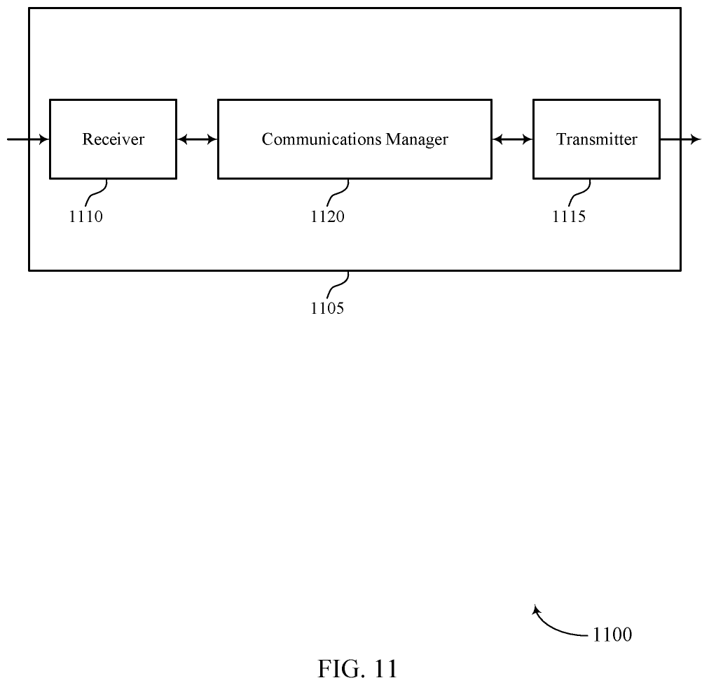

FIG. 11 shows a block diagram 1100 of a device 1105 that supports link adaptation techniques based on channel conditions in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to link adaptation techniques based on channel conditions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to link adaptation techniques based on channel conditions). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of link adaptation techniques based on channel conditions as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. For example, the communications manager 1120 may be configured as or otherwise support a means for transmitting, to a UE, from a base station, an indication of two or more sets of communication parameters for a set of multiple scheduled communications between the UE and the base station. The communications manager 1120 may be configured as or otherwise support a means for selecting, based on a first set of channel conditions between the UE and the base station meeting a first threshold value, a first set of communication parameters from the two or more sets of communication parameters. The communications manager 1120 may be configured as or otherwise support a means for communicating with the UE according to the selected first set of communication parameters for at least a first communication of the set of multiple scheduled communications. The communications manager 1120 may be configured as or otherwise support a means for selecting, based on a second set of channel conditions between the UE and the base station meeting a second threshold value, a second set of communication parameters from the two or more sets of communication parameters, where the first threshold value is different than the second threshold value. The communications manager 1120 may be configured as or otherwise support a means for communicating with the UE according to the selected second set of communication parameters for at least a second communication of the set of multiple scheduled communications.

Additionally or alternatively, the communications manager 1120 may support wireless communication at a base station in accordance with examples as disclosed herein. For example, the communications manager 1120 may be configured as or otherwise support a means for transmitting, to a UE, an indication of two or more sets of communication parameters for a set of multiple scheduled downlink communications from the base station. The communications manager 1120 may be configured as or otherwise support a means for selecting, based on a number of uplink communications from the UE during a prior time window, a first set of communication parameters from the two or more sets of communication parameters. The communications manager 1120 may be configured as or otherwise support a means for communicating with the UE according to the selected first set of communication parameters.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for efficient adjustment of communication parameters based on channel conditions, a number of prior communications, or any combinations thereof. Adjusting communication parameters may allow for enhanced efficiency and reliability of communications with reduced signaling overhead associated with particular instances of scheduled communications. Such techniques may thus enhance communications efficiency, increase data rates and reliability, and provide for enhanced user experience.

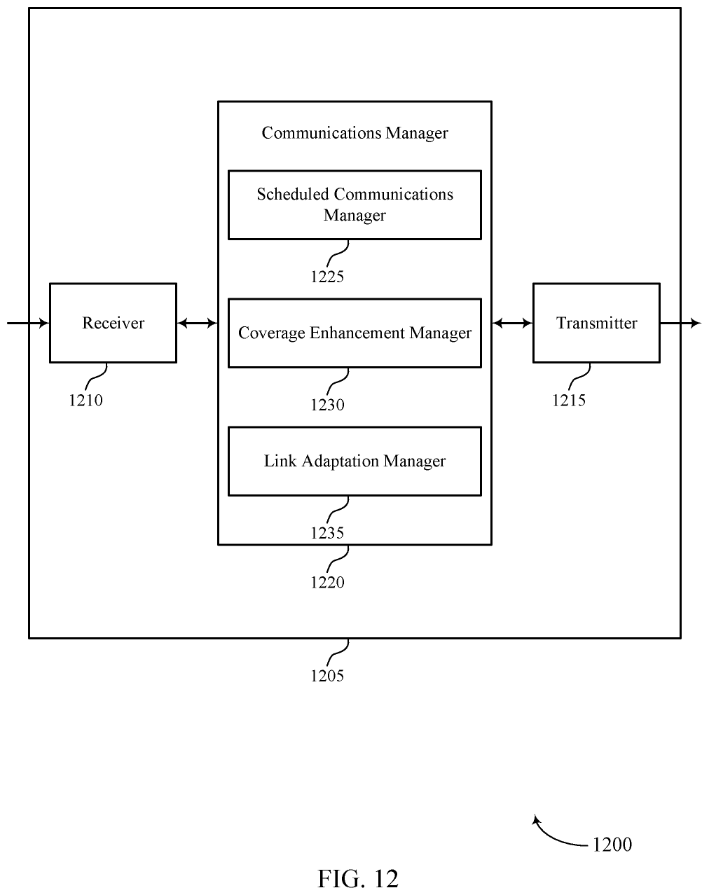

FIG. 12 shows a block diagram 1200 of a device 1205 that supports link adaptation techniques based on channel conditions in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to link adaptation techniques based on channel conditions). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to link adaptation techniques based on channel conditions). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of link adaptation techniques based on channel conditions as described herein. For example, the communications manager 1220 may include a scheduled communications manager 1225, a coverage enhancement manager 1230, a link adaptation manager 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. The scheduled communications manager 1225 may be configured as or otherwise support a means for transmitting, to a UE, from a base station, an indication of two or more sets of communication parameters for a set of multiple scheduled communications between the UE and the base station. The coverage enhancement manager 1230 may be configured as or otherwise support a means for selecting, based on a first set of channel conditions between the UE and the base station meeting a first threshold value, a first set of communication parameters from the two or more sets of communication parameters. The scheduled communications manager 1225 may be configured as or otherwise support a means for communicating with the UE according to the selected first set of communication parameters for at least a first communication of the set of multiple scheduled communications. The coverage enhancement manager 1230 may be configured as or otherwise support a means for selecting, based on a second set of channel conditions between the UE and the base station meeting a second threshold value, a second set of communication parameters from the two or more sets of communication parameters, where the first threshold value is different than the second threshold value. The scheduled communications manager 1225 may be configured as or otherwise support a means for communicating with the UE according to the selected second set of communication parameters for at least a second communication of the set of multiple scheduled communications.

Additionally or alternatively, the communications manager 1220 may support wireless communication at a base station in accordance with examples as disclosed herein. The scheduled communications manager 1225 may be configured as or otherwise support a means for transmitting, to a UE, an indication of two or more sets of communication parameters for a set of multiple scheduled downlink communications from the base station. The link adaptation manager 1235 may be configured as or otherwise support a means for selecting, based on a number of uplink communications from the UE during a prior time window, a first set of communication parameters from the two or more sets of communication parameters. The scheduled communications manager 1225 may be configured as or otherwise support a means for communicating with the UE according to the selected first set of communication parameters.

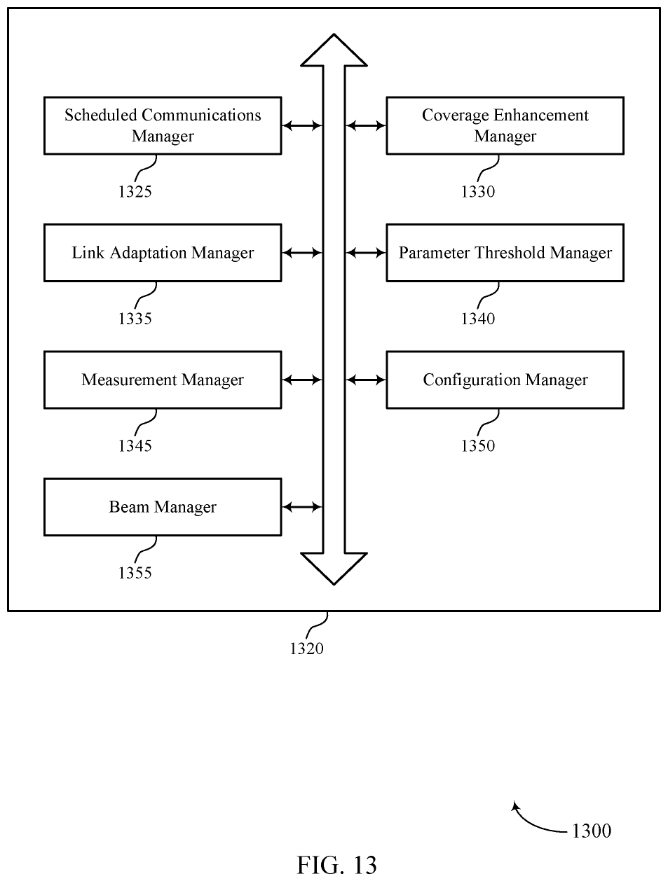

FIG. 13 shows a block diagram 1300 of a communications manager 1320 that supports link adaptation techniques based on channel conditions in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of link adaptation techniques based on channel conditions as described herein. For example, the communications manager 1320 may include a scheduled communications manager 1325, a coverage enhancement manager 1330, a link adaptation manager 1335, a parameter threshold manager 1340, a measurement manager 1345, a configuration manager 1350, a beam manager 1355, or any combination thereof. Each of these components may communicate, directly or indirectly, with one another (e.g., via one or more buses).

The communications manager 1320 may support wireless communication at a base station in accordance with examples as disclosed herein. The scheduled communications manager 1325 may be configured as or otherwise support a means for transmitting, to a UE, from a base station, an indication of two or more sets of communication parameters for a set of multiple scheduled communications between the UE and the base station. The coverage enhancement manager 1330 may be configured as or otherwise support a means for selecting, based on a first set of channel conditions between the UE and the base station meeting a first threshold value, a first set of communication parameters from the two or more sets of communication parameters. In some examples, the scheduled communications manager 1325 may be configured as or otherwise support a means for communicating with the UE according to the selected first set of communication parameters for at least a first communication of the set of multiple scheduled communications. In some examples, the coverage enhancement manager 1330 may be configured as or otherwise support a means for selecting, based on a second set of channel conditions between the UE and the base station meeting a second threshold value, a second set of communication parameters from the two or more sets of communication parameters, where the first threshold value is different than the second threshold value. In some examples, the scheduled communications manager 1325 may be configured as or otherwise support a means for communicating with the UE according to the selected second set of communication parameters for at least a second communication of the set of multiple scheduled communications.

In some examples, the second set of communication parameters provide resources for multiple repetitions of at least the second communication according to a coverage enhancement configuration, and where the first set of communication parameters provide fewer resources than the second set of communication parameters for fewer or no repetitions of the first communication. In some examples, the first threshold value for selecting the first set of communication parameters is higher than the second threshold value for selecting the second set of communication parameters. In some examples, the first set of channel conditions and the second set of channel conditions each include one or more of a RSRP measurement, a SINR, or a CQI measurement.

In some examples, the measurement manager 1345 may be configured as or otherwise support a means for receiving, from the UE, a measurement report that includes the first set of channel conditions, and where the first set of communication parameters are selected based on the measurement report.

In some examples, the second set of communication parameters, provides one or more of an increased number of repetitions of communications relative to the first set of communication parameters, frequency hopping among multiple repetitions of the second communication, a different uplink control channel format or resource set than provided by the first set of communication parameters, a different MCS than a MCS of the first set of communication parameters, different time or frequency resources for communications than the first set of communication parameters, or any combinations thereof. In some examples, the two or more sets of communication parameters include two or more sets of configured grant parameters for uplink transmissions from the UE, include two or more sets of semi-persistent scheduling parameters for downlink transmissions to the UE, or any combinations thereof.

Additionally or alternatively, the communications manager 1320 may support wireless communication at a base station in accordance with examples as disclosed herein. In some examples, the scheduled communications manager 1325 may be configured as or otherwise support a means for transmitting, to a UE, an indication of two or more sets of communication parameters for a set of multiple scheduled downlink communications from the base station. The link adaptation manager 1335 may be configured as or otherwise support a means for selecting, based on a number of uplink communications from the UE during a prior time window, a first set of communication parameters from the two or more sets of communication parameters. In some examples, the scheduled communications manager 1325 may be configured as or otherwise support a means for communicating with the UE according to the selected first set of communication parameters. In some examples, the first set of communication parameters provide for an increased data rate for communications with the UE than a second set of communication parameters of the two or more sets of communication parameters, and where the first set of communication parameters is selected based on the number of uplink communications during the prior time window being above a threshold value.

In some examples, the configuration manager 1350 may be configured as or otherwise support a means for transmitting, to the UE, configuration information that indicates a duration of the prior time window. In some examples, the duration of the prior time window is based on one or more of a prior number of slots, a prior number of scheduled downlink communications monitoring occasions, or an absolute time value. In some examples, different sets of communication parameters of the two or more sets of communication parameters provide one or more of different time resources, different frequency resources, different MCSs, different MIMO ranks, or any combinations thereof.

In some examples, the link adaptation manager 1335 may be configured as or otherwise support a means for determining a duration of the prior time window based at least in part on whether the UE is configured to transmit acknowledgment-only feedback or acknowledgment/negative-acknowledgment feedback for the set of multiple scheduled downlink communications. In some examples, each of the two or more sets of communication parameters are associated with different ranges of the number of uplink communications to the base station during the prior time window. In some examples, each of the two or more sets of communication parameters provide different link-budget gains over a baseline link budget estimate. In some examples, the selecting is further based on the set of multiple scheduled downlink communications having a same TCI state and beam as the number of uplink communications from the UE during the prior time window.

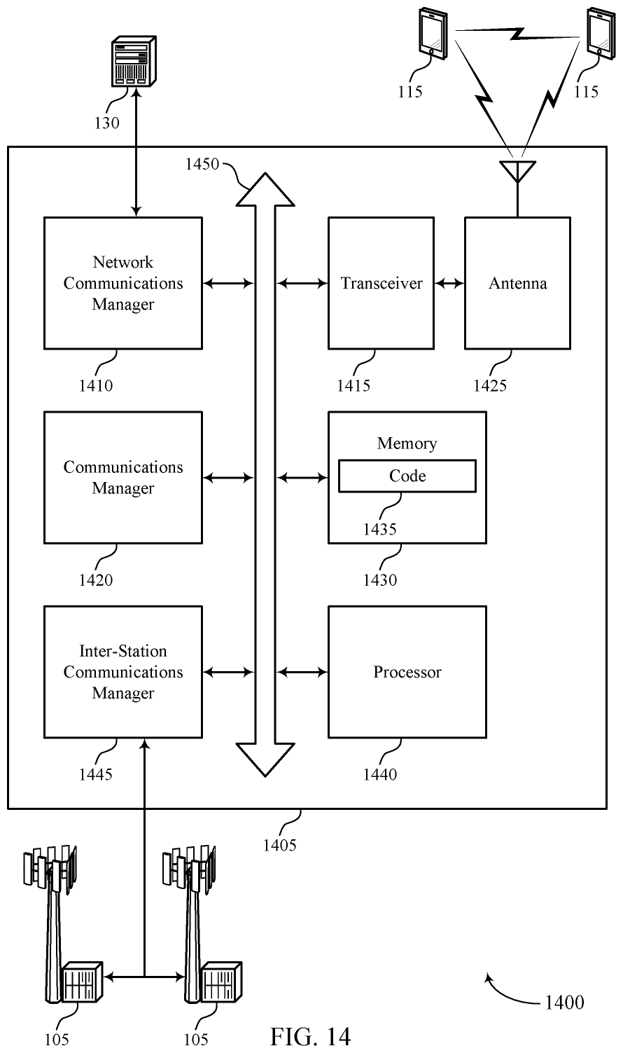

FIG. 14 shows a diagram of a system 1400 including a device 1405 that supports link adaptation techniques based on channel conditions in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting link adaptation techniques based on channel conditions). For example, the device 1405 or a component of the device 1405 may include a processor 1440 and memory 1430 coupled with the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a base station in accordance with examples as disclosed herein. For example, the communications manager 1420 may be configured as or otherwise support a means for transmitting, to a UE, from a base station, an indication of two or more sets of communication parameters for a set of multiple scheduled communications between the UE and the base station. The communications manager 1420 may be configured as or otherwise support a means for selecting, based on a first set of channel conditions between the UE and the base station meeting a first threshold value, a first set of communication parameters from the two or more sets of communication parameters. The communications manager 1420 may be configured as or otherwise support a means for communicating with the UE according to the selected first set of communication parameters for at least a first communication of the set of multiple scheduled communications. The communications manager 1420 may be configured as or otherwise support a means for selecting, based on a second set of channel conditions between the UE and the base station meeting a second threshold value, a second set of communication parameters from the two or more sets of communication parameters, where the first threshold value is different than the second threshold value. The communications manager 1420 may be configured as or otherwise support a means for communicating with the UE according to the selected second set of communication parameters for at least a second communication of the set of multiple scheduled communications.

Additionally or alternatively, the communications manager 1420 may support wireless communication at a base station in accordance with examples as disclosed herein. For example, the communications manager 1420 may be configured as or otherwise support a means for transmitting, to a UE, an indication of two or more sets of communication parameters for a set of multiple scheduled downlink communications from the base station. The communications manager 1420 may be configured as or otherwise support a means for selecting, based on a number of uplink communications from the UE during a prior time window, a first set of communication parameters from the two or more sets of communication parameters. The communications manager 1420 may be configured as or otherwise support a means for communicating with the UE according to the selected first set of communication parameters.

By including or configuring the communications manager 1420 in accordance with examples as described herein, the device 1405 may support techniques for efficient adjustment of communication parameters based on channel conditions, a number of prior communications, or any combinations thereof. Adjusting communication parameters may allow for enhanced efficiency and reliability of communications with reduced signaling overhead associated with particular instances of scheduled communications. Such techniques may thus enhance communications efficiency, increase data rates and reliability, and provide for enhanced user experience.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of link adaptation techniques based on channel conditions as described herein, or the processor 1440 and the memory 1430 may be otherwise configured to perform or support such operations.

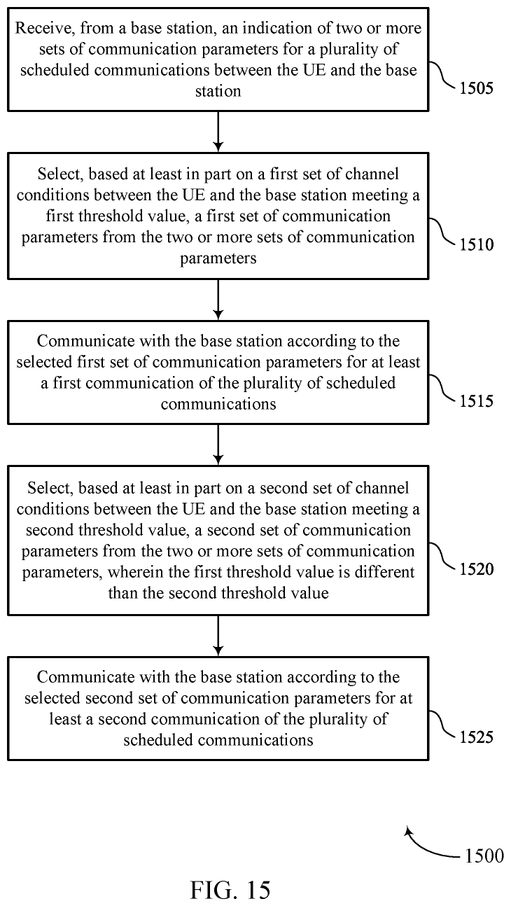

FIG. 15 shows a flowchart illustrating a method 1500 that supports link adaptation techniques based on channel conditions in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, an indication of two or more sets of communication parameters for a set of multiple scheduled communications between the UE and the base station. The operations of 1505 may be performed in accordance with examples as disclosed herein. In some examples, aspects of the operations of 1505 may be performed by a scheduled communications manager 925 as described with reference to FIG. 9.

At 1510, the method may include selecting, based on a first set of channel conditions between the UE and the base station meeting a first threshold value, a first set of communication parameters from the two or more sets of communication parameters. The operations of 1510 may be performed in accordance with examples as disclosed herein. In some examples, aspects of the operations of 1510 may be performed by a coverage enhancement manager 930 as described with reference to FIG. 9.

At 1515, the method may include communicating with the base station according to the selected first set of communication parameters for at least a first communication of the set of multiple scheduled communications. The operations of 1515 may be performed in accordance with examples as disclosed herein. In some examples, aspects of the operations of 1515 may be performed by a scheduled communications manager 925 as described with reference to FIG. 9.

At 1520, the method may include selecting, based on a second set of channel conditions between the UE and the base station meeting a second threshold value, a second set of communication parameters from the two or more sets of communication parameters, where the first threshold value is different than the second threshold value. The operations of 1520 may be performed in accordance with examples as disclosed herein. In some examples, aspects of the operations of 1520 may be performed by a coverage enhancement manager 930 as described with reference to FIG. 9.

At 1525, the method may include communicating with the base station according to the selected second set of communication parameters for at least a second communication of the set of multiple scheduled communications. The operations of 1525 may be performed in accordance with examples as disclosed herein. In some examples, aspects of the operations of 1525 may be performed by a scheduled communications manager 925 as described with reference to FIG. 9.

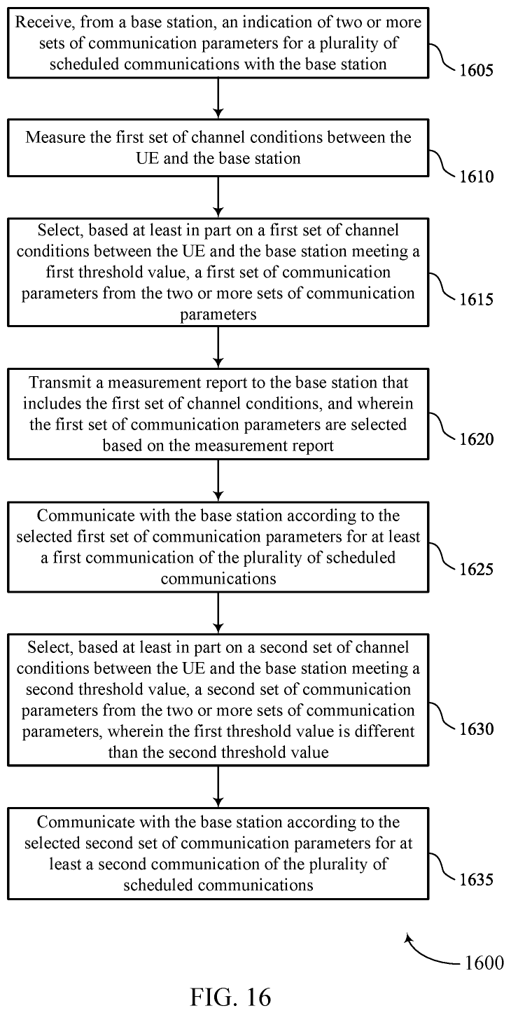

FIG. 16 shows a flowchart illustrating a method 1600 that supports link adaptation techniques based on channel conditions in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, an indication of two or more sets of communication parameters for a set of multiple scheduled communications between the UE and the base station. The operations of 1605 may be performed in accordance with examples as disclosed herein. In some examples, aspects of the operations of 1605 may be performed by a scheduled communications manager 925 as described with reference to FIG. 9.

At 1610, the method may include measuring the first set of channel conditions between the UE and the base station. The operations of 1610 may be performed in accordance with examples as disclosed herein. In some examples, aspects of the operations of 1610 may be performed by a measurement manager 945 as described with reference to FIG. 9.

At 1615, the method may include selecting, based on a first set of channel conditions between the UE and the base station meeting a first threshold value, a first set of communication parameters from the two or more sets of communication parameters. The operations of 1615 may be performed in accordance with examples as disclosed herein. In some examples, aspects of the operations of 1615 may be performed by a coverage enhancement manager 930 as described with reference to FIG. 9.

At 1620, the method may include transmitting a measurement report to the base station that includes the first set of channel conditions, and where the first set of communication parameters are selected based on the measurement report. The operations of 1620 may be performed in accordance with examples as disclosed herein. In some examples, aspects of the operations of 1620 may be performed by a measurement manager 945 as described with reference to FIG. 9.

At 1625, the method may include communicating with the base station according to the selected first set of communication parameters for at least a first communication of the set of multiple scheduled communications. The operations of 1625 may be performed in accordance with examples as disclosed herein. In some examples, aspects of the operations of 1625 may be performed by a scheduled communications manager 925 as described with reference to FIG. 9.

At 1630, the method may include selecting, based on a second set of channel conditions between the UE and the base station meeting a second threshold value, a second set of communication parameters from the two or more sets of communication parameters, where the first threshold value is different than the second threshold value. The operations of 1630 may be performed in accordance with examples as disclosed herein. In some examples, aspects of the operations of 1630 may be performed by a coverage enhancement manager 930 as described with reference to FIG. 9.

At 1635, the method may include communicating with the base station according to the selected second set of communication parameters for at least a second communication of the set of multiple scheduled communications. The operations of 1635 may be performed in accordance with examples as disclosed herein. In some examples, aspects of the operations of 1635 may be performed by a scheduled communications manager 925 as described with reference to FIG. 9.

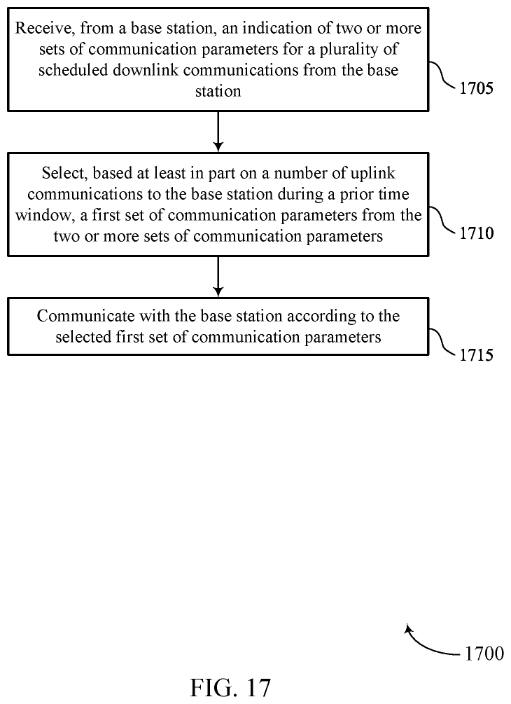

FIG. 17 shows a flowchart illustrating a method 1700 that supports link adaptation techniques based on channel conditions in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, an indication of two or more sets of communication parameters for a set of multiple scheduled downlink communications from the base station. The operations of 1705 may be performed in accordance with examples as disclosed herein. In some examples, aspects of the operations of 1705 may be performed by a scheduled communications manager 925 as described with reference to FIG. 9.

At 1710, the method may include selecting, based on a number of uplink communications to the base station during a prior time window, a first set of communication parameters from the two or more sets of communication parameters. The operations of 1710 may be performed in accordance with examples as disclosed herein. In some examples, aspects of the operations of 1710 may be performed by a link adaptation manager 935 as described with reference to FIG. 9.

At 1715, the method may include communicating with the base station according to the selected first set of communication parameters. The operations of 1715 may be performed in accordance with examples as disclosed herein. In some examples, aspects of the operations of 1715 may be performed by a scheduled communications manager 925 as described with reference to FIG. 9.

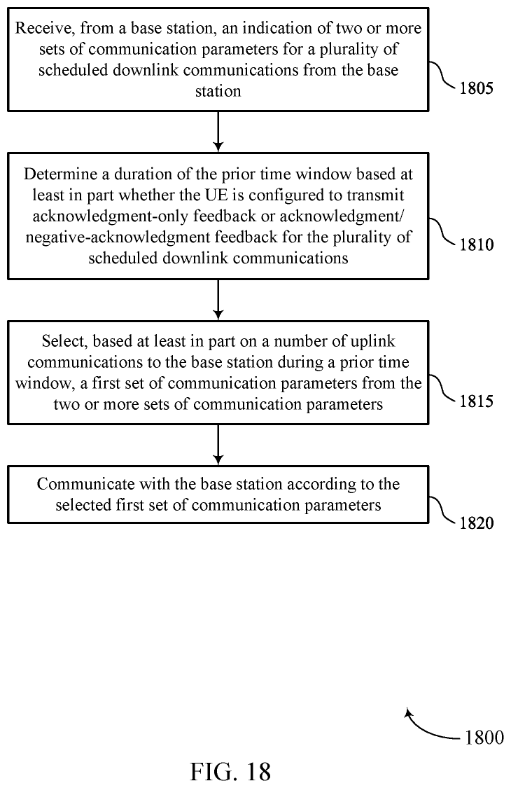

FIG. 18 shows a flowchart illustrating a method 1800 that supports link adaptation techniques based on channel conditions in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, an indication of two or more sets of communication parameters for a set of multiple scheduled downlink communications from the base station. The operations of 1805 may be performed in accordance with examples as disclosed herein. In some examples, aspects of the operations of 1805 may be performed by a scheduled communications manager 925 as described with reference to FIG. 9.

At 1810, the method may include determining a duration of the prior time window based at least in part on whether the UE is configured to transmit acknowledgment-only feedback or acknowledgment/negative-acknowledgment feedback for the set of multiple scheduled downlink communications. The operations of 1810 may be performed in accordance with examples as disclosed herein. In some examples, aspects of the operations of 1810 may be performed by a link adaptation manager 935 as described with reference to FIG. 9.

At 1815, the method may include selecting, based on a number of uplink communications to the base station during a prior time window, a first set of communication parameters from the two or more sets of communication parameters. The operations of 1815 may be performed in accordance with examples as disclosed herein. In some examples, aspects of the operations of 1815 may be performed by a link adaptation manager 935 as described with reference to FIG. 9.

At 1820, the method may include communicating with the base station according to the selected first set of communication parameters. The operations of 1820 may be performed in accordance with examples as disclosed herein. In some examples, aspects of the operations of 1820 may be performed by a scheduled communications manager 925 as described with reference to FIG. 9.

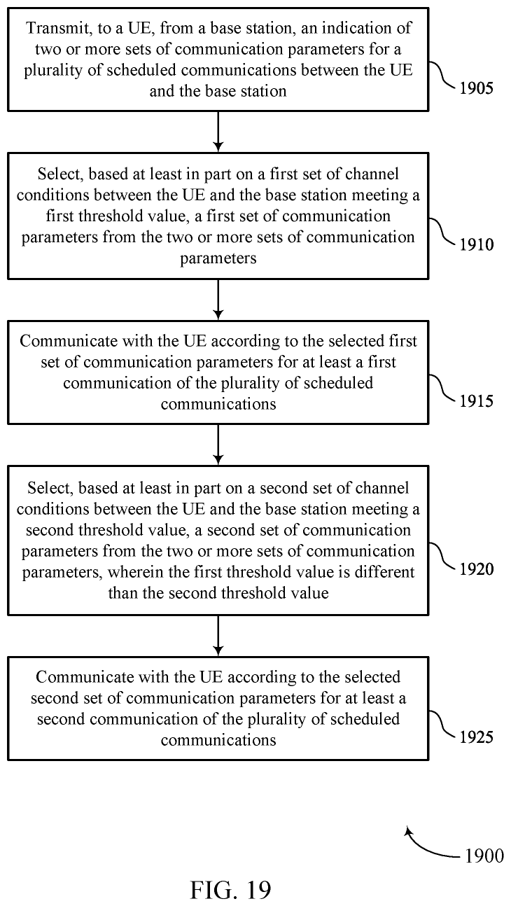

FIG. 19 shows a flowchart illustrating a method 1900 that supports link adaptation techniques based on channel conditions in accordance with aspects of the present disclosure. The operations of the method 1900 may be implemented by a base station or its components as described herein. For example, the operations of the method 1900 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1905, the method may include transmitting, to a UE, from a base station, an indication of two or more sets of communication parameters for a set of multiple scheduled communications between the UE and the base station. The operations of 1905 may be performed in accordance with examples as disclosed herein. In some examples, aspects of the operations of 1905 may be performed by a scheduled communications manager 1325 as described with reference to FIG. 13.

At 1910, the method may include selecting, based on a first set of channel conditions between the UE and the base station meeting a first threshold value, a first set of communication parameters from the two or more sets of communication parameters. The operations of 1910 may be performed in accordance with examples as disclosed herein. In some examples, aspects of the operations of 1910 may be performed by a coverage enhancement manager 1330 as described with reference to FIG. 13.

At 1915, the method may include communicating with the UE according to the selected first set of communication parameters for at least a first communication of the set of multiple scheduled communications. The operations of 1915 may be performed in accordance with examples as disclosed herein. In some examples, aspects of the operations of 1915 may be performed by a scheduled communications manager 1325 as described with reference to FIG. 13.

At 1920, the method may include selecting, based on a second set of channel conditions between the UE and the base station meeting a second threshold value, a second set of communication parameters from the two or more sets of communication parameters, where the first threshold value is different than the second threshold value. The operations of 1920 may be performed in accordance with examples as disclosed herein. In some examples, aspects of the operations of 1920 may be performed by a coverage enhancement manager 1330 as described with reference to FIG. 13.

At 1925, the method may include communicating with the UE according to the selected second set of communication parameters for at least a second communication of the set of multiple scheduled communications. The operations of 1925 may be performed in accordance with examples as disclosed herein. In some examples, aspects of the operations of 1925 may be performed by a scheduled communications manager 1325 as described with reference to FIG. 13.

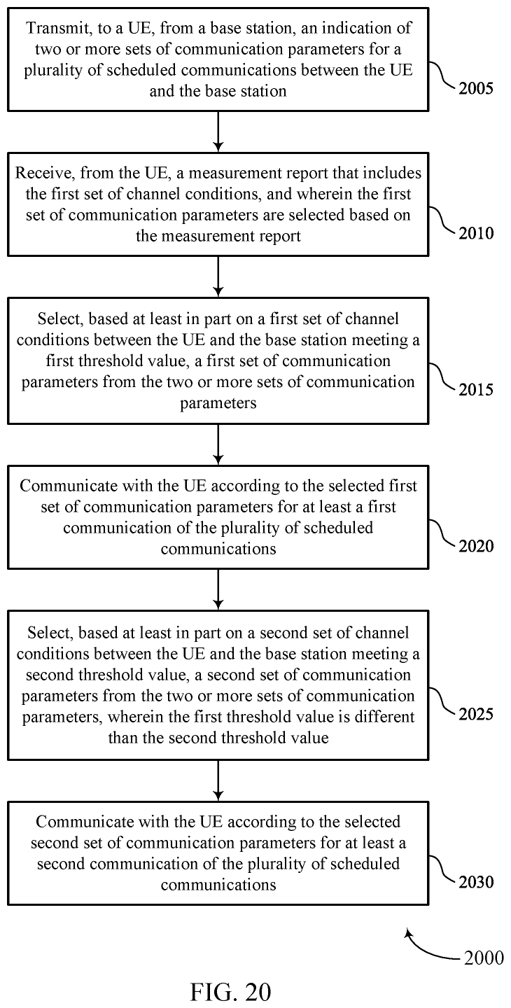

FIG. 20 shows a flowchart illustrating a method 2000 that supports link adaptation techniques based on channel conditions in accordance with aspects of the present disclosure. The operations of the method 2000 may be implemented by a base station or its components as described herein. For example, the operations of the method 2000 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2005, the method may include transmitting, to a UE, from a base station, an indication of two or more sets of communication parameters for a set of multiple scheduled communications between the UE and the base station. The operations of 2005 may be performed in accordance with examples as disclosed herein. In some examples, aspects of the operations of 2005 may be performed by a scheduled communications manager 1325 as described with reference to FIG. 13.

At 2010, the method may include receiving, from the UE, a measurement report that includes the first set of channel conditions, and where the first set of communication parameters are selected based on the measurement report. The operations of 2010 may be performed in accordance with examples as disclosed herein. In some examples, aspects of the operations of 2010 may be performed by a measurement manager 1345 as described with reference to FIG. 13.

At 2015, the method may include selecting, based on a first set of channel conditions between the UE and the base station meeting a first threshold value, a first set of communication parameters from the two or more sets of communication parameters. The operations of 2015 may be performed in accordance with examples as disclosed herein. In some examples, aspects of the operations of 2015 may be performed by a coverage enhancement manager 1330 as described with reference to FIG. 13.

At 2020, the method may include communicating with the UE according to the selected first set of communication parameters for at least a first communication of the set of multiple scheduled communications. The operations of 2020 may be performed in accordance with examples as disclosed herein. In some examples, aspects of the operations of 2020 may be performed by a scheduled communications manager 1325 as described with reference to FIG. 13.

At 2025, the method may include selecting, based on a second set of channel conditions between the UE and the base station meeting a second threshold value, a second set of communication parameters from the two or more sets of communication parameters, where the first threshold value is different than the second threshold value. The operations of 2025 may be performed in accordance with examples as disclosed herein. In some examples, aspects of the operations of 2025 may be performed by a coverage enhancement manager 1330 as described with reference to FIG. 13.

At 2030, the method may include communicating with the UE according to the selected second set of communication parameters for at least a second communication of the set of multiple scheduled communications. The operations of 2030 may be performed in accordance with examples as disclosed herein. In some examples, aspects of the operations of 2030 may be performed by a scheduled communications manager 1325 as described with reference to FIG. 13.

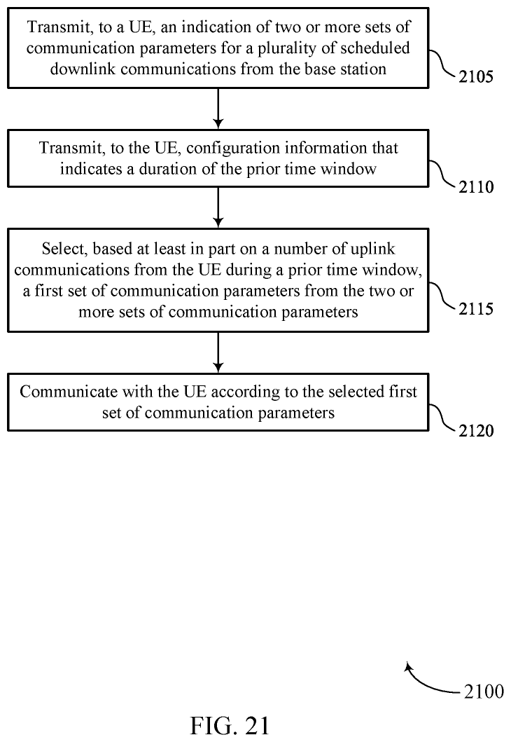

FIG. 21 shows a flowchart illustrating a method 2100 that supports link adaptation techniques based on channel conditions in accordance with aspects of the present disclosure. The operations of the method 2100 may be implemented by a base station or its components as described herein. For example, the operations of the method 2100 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2105, the method may include transmitting, to a UE, an indication of two or more sets of communication parameters for a set of multiple scheduled downlink communications from the base station. The operations of 2105 may be performed in accordance with examples as disclosed herein. In some examples, aspects of the operations of 2105 may be performed by a scheduled communications manager 1325 as described with reference to FIG. 13.

At 2110, the method may include transmitting, to the UE, configuration information that indicates a duration of the prior time window. The operations of 2110 may be performed in accordance with examples as disclosed herein. In some examples, aspects of the operations of 2110 may be performed by a configuration manager 1350 as described with reference to FIG. 13.

At 2115, the method may include selecting, based on a number of uplink communications from the UE during a prior time window, a first set of communication parameters from the two or more sets of communication parameters. The operations of 2115 may be performed in accordance with examples as disclosed herein. In some examples, aspects of the operations of 2115 may be performed by a link adaptation manager 1335 as described with reference to FIG. 13.

At 2120, the method may include communicating with the UE according to the selected first set of communication parameters. The operations of 2120 may be performed in accordance with examples as disclosed herein. In some examples, aspects of the operations of 2120 may be performed by a scheduled communications manager 1325 as described with reference to FIG. 13.

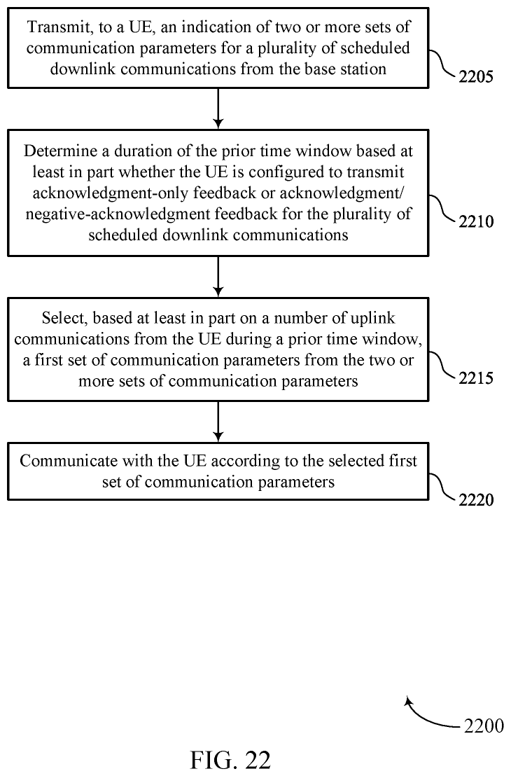

FIG. 22 shows a flowchart illustrating a method 2200 that supports link adaptation techniques based on channel conditions in accordance with aspects of the present disclosure. The operations of the method 2200 may be implemented by a base station or its components as described herein. For example, the operations of the method 2200 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2205, the method may include transmitting, to a UE, an indication of two or more sets of communication parameters for a set of multiple scheduled downlink communications from the base station. The operations of 2205 may be performed in accordance with examples as disclosed herein. In some examples, aspects of the operations of 2205 may be performed by a scheduled communications manager 1325 as described with reference to FIG. 13.

At 2210, the method may include determining a duration of the prior time window based at least in part on whether the UE is configured to transmit acknowledgment-only feedback or acknowledgment/negative-acknowledgment feedback for the set of multiple scheduled downlink communications. The operations of 2210 may be performed in accordance with examples as disclosed herein. In some examples, aspects of the operations of 2210 may be performed by a link adaptation manager 1335 as described with reference to FIG. 13.

At 2215, the method may include selecting, based on a number of uplink communications from the UE during a prior time window, a first set of communication parameters from the two or more sets of communication parameters. The operations of 2215 may be performed in accordance with examples as disclosed herein. In some examples, aspects of the operations of 2215 may be performed by a link adaptation manager 1335 as described with reference to FIG. 13.

At 2220, the method may include communicating with the UE according to the selected first set of communication parameters. The operations of 2220 may be performed in accordance with examples as disclosed herein. In some examples, aspects of the operations of 2220 may be performed by a scheduled communications manager 1325 as described with reference to FIG. 13.

The following provides an overview of aspects of the present disclosure:

Aspect 1: A method for wireless communication at a UE, comprising: receiving, from a base station, an indication of two or more sets of communication parameters for a plurality of scheduled communications between the UE and the base station; selecting, based at least in part on a first set of channel conditions between the UE and the base station meeting a first threshold value, a first set of communication parameters from the two or more sets of communication parameters; communicating with the base station according to the selected first set of communication parameters for at least a first communication of the plurality of scheduled communications; selecting, based at least in part on a second set of channel conditions between the UE and the base station meeting a second threshold value, a second set of communication parameters from the two or more sets of communication parameters, wherein the first threshold value is different than the second threshold value; and communicating with the base station according to the selected second set of communication parameters for at least a second communication of the plurality of scheduled communications.

Aspect 2: The method of aspect 1, wherein the second set of communication parameters provide resources for multiple repetitions of at least the second communication according to a coverage enhancement configuration, and wherein the first set of communication parameters provide fewer resources than the second set of communication parameters for fewer or no repetitions of the first communication.

Aspect 3: The method of any of aspects 1 through 2, wherein the first threshold value for selecting the first set of communication parameters is higher than the second threshold value for selecting the second set of communication parameters.

Aspect 4: The method of aspect 3, wherein the first set of channel conditions and the second set of channel conditions each include one or more of a reference signal received power (RSRP) measurement, a signal to interference and noise ratio (SINR), or a channel quality indicator (CQI) measurement.

Aspect 5: The method of any of aspects 1 through 4, further comprising: measuring the first set of channel conditions between the UE and the base station; and transmitting a measurement report to the base station that includes the first set of channel conditions, and wherein the first set of communication parameters are selected based on the measurement report.

Aspect 6: The method of any of aspects 1 through 5, wherein the second set of communication parameters provides an increased number of repetitions of communications relative to the first set of communication parameters, provides frequency hopping among multiple repetitions of the second communication, provide a different uplink control channel format or resource set than provided by the first set of communication parameters, indicates a different modulation and coding scheme (MCS) than a MCS of the first set of communication parameters, indicates different time or frequency resources for communications than the first set of communication parameters, resources, or any combinations thereof.

Aspect 7: The method of any of aspects 1 through 6, wherein the two or more sets of communication parameters include two or more sets of configured grant parameters for uplink transmissions to the base station, include two or more sets of semi-persistent scheduling parameters for downlink transmissions from the base station, or any combinations thereof.

Aspect 8: A method for wireless communication at a UE, comprising: receiving, from a base station, an indication of two or more sets of communication parameters for a plurality of scheduled downlink communications from the base station; selecting, based at least in part on a number of uplink communications to the base station during a prior time window, a first set of communication parameters from the two or more sets of communication parameters; and communicating with the base station according to the selected first set of communication parameters.

Aspect 9: The method of aspect 8, wherein the first set of communication parameters provide for an increased data rate for communications with the base station than a second set of communication parameters of the two or more sets of communication parameters, and wherein the first set of communication parameters is selected based on the number of uplink communications during the prior time window being above a threshold value.

Aspect 10: The method of any of aspects 8 through 9, further comprising: receiving, from the base station, configuration information that indicates a duration of the prior time window.

Aspect 11: The method of aspect 10, wherein the duration of the prior time window is based at least in part on one or more of a prior number of slots, a prior number of scheduled downlink communications monitoring occasions, or an absolute time value.

Aspect 12: The method of any of aspects 8 through 11, wherein different sets of communication parameters of the two or more sets of communication parameters provide one or more of different time resources, different frequency resources, different modulation and coding schemes, different multiple-input multiple-output (MIMO) ranks, or any combinations thereof.

Aspect 13: The method of any of aspects 8 through 12, further comprising: determining a duration of the prior time window based at least in part on whether the UE is configured to transmit acknowledgment-only feedback or acknowledgment/negative-acknowledgment feedback for the plurality of scheduled downlink communications.

Aspect 14: The method of any of aspects 8 through 13, wherein each of the two or more sets of communication parameters are associated with different ranges of the number of uplink communications to the base station during the prior time window.

Aspect 15: The method of any of aspects 8 through 14, wherein each of the two or more sets of communication parameters provide different link-budget gains over a baseline link budget estimate.

Aspect 16: The method of any of aspects 8 through 15, wherein the selecting is further based at least in part on the plurality of scheduled downlink communications having a same transmission configuration indicator (TCI) state and beam as the number of uplink communications to the base station during the prior time window.

Aspect 17: A method for wireless communication at a base station, comprising: transmitting, to a UE, from a base station, an indication of two or more sets of communication parameters for a plurality of scheduled communications between the UE and the base station; selecting, based at least in part on a first set of channel conditions between the UE and the base station meeting a first threshold value, a first set of communication parameters from the two or more sets of communication parameters; communicating with the UE according to the selected first set of communication parameters for at least a first communication of the plurality of scheduled communications; selecting, based at least in part on a second set of channel conditions between the UE and the base station meeting a second threshold value, a second set of communication parameters from the two or more sets of communication parameters, wherein the first threshold value is different than the second threshold value; and communicating with the UE according to the selected second set of communication parameters for at least a second communication of the plurality of scheduled communications.

Aspect 18: The method of aspect 17, wherein the second set of communication parameters provide resources for multiple repetitions of at least the second communication according to a coverage enhancement configuration, and wherein the first set of communication parameters provide fewer resources than the second set of communication parameters for fewer or no repetitions of the first communication.

Aspect 19: The method of any of aspects 17 through 18, wherein the first threshold value for selecting the first set of communication parameters is higher than the second threshold value for selecting the second set of communication parameters.

Aspect 20: The method of aspect 19, wherein the first set of channel conditions and the second set of channel conditions each include one or more of a reference signal received power (RSRP) measurement, a signal to interference and noise ratio (SINR), or a channel quality indicator (CQI) measurement.

Aspect 21: The method of any of aspects 17 through 20, further comprising: receiving, from the UE, a measurement report that includes the first set of channel conditions, and wherein the first set of communication parameters are selected based on the measurement report.

Aspect 22: The method of any of aspects 17 through 21, wherein the second set of communication parameters: provides an increased number of repetitions of communications relative to the first set of communication parameters, provides frequency hopping among multiple repetitions of the second communication, provide a different uplink control channel format or resource set than provided by the first set of communication parameters, indicates a different modulation and coding scheme (MCS) than a MCS of the first set of communication parameters, indicates different time or frequency resources for communications than the first set of communication parameters, resources, or any combinations thereof.

Aspect 23: The method of any of aspects 17 through 22, wherein the two or more sets of communication parameters include two or more sets of configured grant parameters for uplink transmissions from the UE, include two or more sets of semi-persistent scheduling parameters for downlink transmissions to the UE, or any combinations thereof.

Aspect 24: A method for wireless communication at a base station, comprising: transmitting, to a UE, an indication of two or more sets of communication parameters for a plurality of scheduled downlink communications from the base station; selecting, based at least in part on a number of uplink communications from the UE during a prior time window, a first set of communication parameters from the two or more sets of communication parameters; and communicating with the UE according to the selected first set of communication parameters.

Aspect 25: The method of aspect 24, wherein the first set of communication parameters provide for an increased data rate for communications with the UE than a second set of communication parameters of the two or more sets of communication parameters, and wherein the first set of communication parameters is selected based on the number of uplink communications during the prior time window being above a threshold value.

Aspect 26: The method of any of aspects 24 through 25, further comprising: transmitting, to the UE, configuration information that indicates a duration of the prior time window.

Aspect 27: The method of aspect 26, wherein the duration of the prior time window is based at least in part on one or more of a prior number of slots, a prior number of scheduled downlink communications monitoring occasions, or an absolute time value.

Aspect 28: The method of any of aspects 24 through 27, wherein different sets of communication parameters of the two or more sets of communication parameters provide one or more of different time resources, different frequency resources, different modulation and coding schemes, different multiple-input multiple-output (MIMO) ranks, or any combinations thereof.

Aspect 29: The method of any of aspects 24 through 28, further comprising: determining a duration of the prior time window based at least in part on whether the UE is configured to transmit acknowledgment-only feedback or acknowledgment/negative-acknowledgment feedback for the plurality of scheduled downlink communications.

Aspect 30: The method of any of aspects 24 through 29, wherein each of the two or more sets of communication parameters are associated with different ranges of the number of uplink communications to the base station during the prior time window.

Aspect 31: The method of any of aspects 24 through 30, wherein each of the two or more sets of communication parameters provide different link-budget gains over a baseline link budget estimate.

Aspect 32: The method of any of aspects 24 through 31, wherein the selecting is further based at least in part on the plurality of scheduled downlink communications having a same transmission configuration indicator (TCI) state and beam as the number of uplink communications from the UE during the prior time window.

Aspect 33: An apparatus for wireless communication at a UE, comprising a processor; memory coupled with the processor; and instructions stored in the memory and executable by the processor to cause the apparatus to perform a method of any of aspects 1 through 7.

Aspect 34: An apparatus for wireless communication at a UE, comprising at least one means for performing a method of any of aspects 1 through 7.

Aspect 35: A non-transitory computer-readable medium storing code for wireless communication at a UE, the code comprising instructions executable by a processor to perform a method of any of aspects 1 through 7.

Aspect 36: An apparatus for wireless communication at a UE, comprising a processor; memory coupled with the processor; and instructions stored in the memory and executable by the processor to cause the apparatus to perform a method of any of aspects 8 through 16.

Aspect 37: An apparatus for wireless communication at a UE, comprising at least one means for performing a method of any of aspects 8 through 16.

Aspect 38: A non-transitory computer-readable medium storing code for wireless communication at a UE, the code comprising instructions executable by a processor to perform a method of any of aspects 8 through 16.

Aspect 39: An apparatus for wireless communication at a base station, comprising a processor; memory coupled with the processor; and instructions stored in the memory and executable by the processor to cause the apparatus to perform a method of any of aspects 17 through 23.

Aspect 40: An apparatus for wireless communication at a base station, comprising at least one means for performing a method of any of aspects 17 through 23.

Aspect 41: A non-transitory computer-readable medium storing code for wireless communication at a base station, the code comprising instructions executable by a processor to perform a method of any of aspects 17 through 23.

Aspect 42: An apparatus for wireless communication at a base station, comprising a processor; memory coupled with the processor; and instructions stored in the memory and executable by the processor to cause the apparatus to perform a method of any of aspects 24 through 32.

Aspect 43: An apparatus for wireless communication at a base station, comprising at least one means for performing a method of any of aspects 24 through 32.

Aspect 44: A non-transitory computer-readable medium storing code for wireless communication at a base station, the code comprising instructions executable by a processor to perform a method of any of aspects 24 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, an indication of two or more sets of communication parameters for a plurality of scheduled communications between the UE and the base station;
selecting, based at least in part on a first set of channel conditions between the UE and the base station meeting a first threshold value, a first set of communication parameters from the two or more sets of communication parameters;
communicating with the base station according to the selected first set of communication parameters for at least a first communication of the plurality of scheduled communications;
selecting, based at least in part on a second set of channel conditions between the UE and the base station meeting a second threshold value, a second set of communication parameters from the two or more sets of communication parameters, wherein the first threshold value is different than the second threshold value; and
communicating with the base station according to the selected second set of communication parameters for at least a second communication of the plurality of scheduled communications.

2. The method of claim 1, wherein the second set of communication parameters provide resources for multiple repetitions of at least the second communication according to a coverage enhancement configuration, and wherein the first set of communication parameters provide fewer resources than the second set of communication parameters for fewer or no repetitions of the first communication.

3. The method of claim 1, wherein the first threshold value for selecting the first set of communication parameters is higher than the second threshold value for selecting the second set of communication parameters.

4. The method of claim 3, wherein the first set of channel conditions and the second set of channel conditions each include one or more of a reference signal received power (RSRP) measurement, a signal to interference and noise ratio (SINR), or a channel quality indicator (CQI) measurement.

5. The method of claim 1, further comprising:
measuring the first set of channel conditions between the UE and the base station; and
transmitting a measurement report to the base station that includes the first set of channel conditions, and wherein the first set of communication parameters are selected based on the measurement report.

6. The method of claim 1, wherein the second set of communication parameters:
provides an increased number of repetitions of communications relative to the first set of communication parameters,
provides frequency hopping among multiple repetitions of the second communication,
provide a different uplink control channel format or resource set than provided by the first set of communication parameters,
indicates a different modulation and coding scheme (MCS) than a MCS of the first set of communication parameters,
indicates different time or frequency resources for communications than the first set of communication parameters,
or any combinations thereof.

7. The method of claim 1, wherein the two or more sets of communication parameters include two or more sets of configured grant parameters for uplink transmissions to the base station, include two or more sets of semi-persistent scheduling parameters for downlink transmissions from the base station, or any combinations thereof.

8. A method for wireless communication at a user equipment (UE), comprising:
receiving, from a base station, an indication of two or more sets of communication parameters for a plurality of scheduled downlink communications from the base station;
selecting, based at least in part on a number of uplink communications to the base station during a prior time window, a first set of communication parameters from the two or more sets of communication parameters; and
communicating with the base station according to the selected first set of communication parameters.

9. The method of claim 8, wherein the first set of communication parameters provide for an increased data rate for communications with the base station than a second set of communication parameters of the two or more sets of communication parameters, and wherein the first set of communication parameters is selected based on the number of uplink communications during the prior time window being above a threshold value.

10. The method of claim 8, further comprising:
receiving, from the base station, configuration information that indicates a duration of the prior time window.

11. The method of claim 10, wherein the duration of the prior time window is based at least in part on one or more of a prior number of slots, a prior number of scheduled downlink communications monitoring occasions, or an absolute time value.

12. The method of claim 8, wherein different sets of communication parameters of the two or more sets of communication parameters provide one or more of different time resources, different frequency resources, different modulation and coding schemes, different multiple-input multiple-output (MIMO) ranks, or any combinations thereof.

13. The method of claim 8, further comprising:
determining a duration of the prior time window based at least in part on whether the UE is configured to transmit acknowledgment-only feedback or acknowledgment/negative-acknowledgment feedback for the plurality of scheduled downlink communications.

14. The method of claim 8, wherein each of the two or more sets of communication parameters are associated with different ranges of the number of uplink communications to the base station during the prior time window.

15. The method of claim 8, wherein each of the two or more sets of communication parameters provide different link-budget gains over a baseline link budget estimate.

16. The method of claim 8, wherein the selecting is further based at least in part on the plurality of scheduled downlink communications having a same transmission configuration indicator (TCI) state and beam as the number of uplink communications to the base station during the prior time window.

17. An apparatus for wireless communication at a user equipment (UE), comprising:
a processor;
memory coupled with the processor; and
instructions stored in the memory and executable by the processor to cause the apparatus to:
receive, from a base station, an indication of two or more sets of communication parameters for a plurality of scheduled communications between the UE and the base station;
select, based at least in part on a first set of channel conditions between the UE and the base station meeting a first threshold value, a first set of communication parameters from the two or more sets of communication parameters;
communicate with the base station according to the selected first set of communication parameters for at least a first communication of the plurality of scheduled communications;
select, based at least in part on a second set of channel conditions between the UE and the base station meeting a second threshold value, a second set of communication parameters from the two or more sets of communication parameters, wherein the first threshold value is different than the second threshold value; and
communicate with the base station according to the selected second set of communication parameters for at least a second communication of the plurality of scheduled communications.

18. The apparatus of claim 17, wherein the second set of communication parameters provide resources for multiple repetitions of at least the second communication according to a coverage enhancement configuration, and wherein the first set of communication parameters provide fewer resources than the second set of communication parameters for fewer or no repetitions of the first communication.

19. The apparatus of claim 17, wherein the first threshold value for selecting the first set of communication parameters is higher than the second threshold value for selecting the second set of communication parameters.

20. The apparatus of claim 19, wherein the first set of channel conditions and the second set of channel conditions each include one or more of a reference signal received power (RSRP) measurement, a signal to interference and noise ratio (SINR), or a channel quality indicator (CQI) measurement.

21. The apparatus of claim 17, wherein the instructions are further executable by the processor to cause the apparatus to:
measure the first set of channel conditions between the UE and the base station; and
transmit a measurement report to the base station that includes the first set of channel conditions, and wherein the first set of communication parameters are selected based on the measurement report.

22. The apparatus of claim 17, wherein the two or more sets of communication parameters include two or more sets of configured grant parameters for uplink transmissions to the base station, include two or more sets of semi-persistent scheduling parameters for downlink transmissions from the base station, or any combinations thereof.

23. An apparatus for wireless communication at a user equipment (UE), comprising:
a processor;
memory coupled with the processor; and
instructions stored in the memory and executable by the processor to cause the apparatus to:
receive, from a base station, an indication of two or more sets of communication parameters for a plurality of scheduled downlink communications from the base station;
select, based at least in part on a number of uplink communications to the base station during a prior time window, a first set of communication parameters from the two or more sets of communication parameters; and
communicate with the base station according to the selected first set of communication parameters.

24. The apparatus of claim 23, wherein the first set of communication parameters provide for an increased data rate for communications with the base station than a second set of communication parameters of the two or more sets of communication parameters, and wherein the first set of communication parameters is selected based on the number of uplink communications during the prior time window being above a threshold value.

25. The apparatus of claim 23, wherein the instructions are further executable by the processor to cause the apparatus to:
receive, from the base station, configuration information that indicates a duration of the prior time window.

26. The apparatus of claim 23, wherein different sets of communication parameters of the two or more sets of communication parameters provide one or more of different time resources, different frequency resources, different modulation and coding schemes, different multiple-input multiple-output (MIMO) ranks, or any combinations thereof.

27. The apparatus of claim 23, wherein the instructions are further executable by the processor to cause the apparatus to:
determine a duration of the prior time window based at least in part on whether the UE is configured to transmit acknowledgment-only feedback or acknowledgment/negative-acknowledgment feedback for the plurality of scheduled downlink communications.

28. The apparatus of claim 23, wherein each of the two or more sets of communication parameters are associated with different ranges of the number of uplink communications to the base station during the prior time window.

29. The apparatus of claim 23, wherein each of the two or more sets of communication parameters provide different link-budget gains over a baseline link budget estimate.

30. The apparatus of claim 23, wherein the selecting is further based at least in part on the plurality of scheduled downlink communications having a same transmission configuration indicator (TCI) state and beam as the number of uplink communications to the base station during the prior time window.
